(19) United States
(12) Patent Application Publication
(10) Pub. No.: US 2006/0100006 A1
(43) Pub. Date: May 11, 2006

(54) Strategy gaming format with outcomes determined by external events and auction- and market-based transactions by the players

(75) Inventors: Scott Mitchell, Naples, FL (US); Todd Mitchell, Los Angeles, CA (US)

Correspondence Address: AMIN & TUROCY, LLP, 1900 EAST 9TH STREET, NATIONAL CITY CENTER, 24TH FLOOR,, CLEVELAND, OH, 44114, US

(73) Assignee: Onroo Entertainment, LLC, Naples, FL (US)

(21) Appl. No.: 10/986,555

(22) Filed: Nov. 11, 2004

(51) Int. Cl. G06F 17/00; G06F 19/00

(52) U.S. Cl. 463/9

(57) ABSTRACT

A unique gaming format that can be played online and employs procedures for allocating game value units or points among a plurality of users (including through auction bidding and market-based transactions) and applies such procedures to determine certain rights with respect to such game value units or points in a manner that, when combined with certain external events (e.g., a real-life event-RLE), determines the outcome. The RLEs to which the format can be applied include any professional or amateur sports, reality-based television program, competition, or the like. In addition to the applicability to popular domains such as football and baseball, the game format can be applied to a broad variety of participants' particular interests, and can be configured to suit participants' particular playing styles, intensity, and competitive tastes.

### TECHNICAL FIELD

This invention is related to gaming, and more specifically, to a gaming format that employs procedures for allocating game points in a manner that, when combined with certain external events, determines the outcome of a game.

### BACKGROUND OF THE INVENTION

Large numbers of fans and enthusiasts spend an even larger amount of money each year on activities relating to real-life events such as sporting events. Professional baseball, basketball, football, soccer, and hockey, to name just a few, reap billions of dollars in revenues each year. By way of cable and satellite television, viewers can now watch virtually any type of sporting event that occurs in most places in the world. If not directly accessible by television, the user can access such events via the Internet. One source of entertainment related to events of this type is provided by software companies that develop computer games of sports that allow a user to play in the game in a virtual setting and compete against other users. Another source of entertainment related to events of this type is provided in the form of so-called “fantasy” sports leagues, the formats of which are driven largely by individual player statistical performance. Nevertheless, there is no adequate mechanism by which individuals can competitively participate in the outcomes of or events occurring during actual sporting events. For those who are not especially interested in sports, television companies compete for viewers of so-called “reality” shows such as The Apprentice™ and Survivor™ where individuals compete against one another in real-life events for prizes. Again, there is no adequate mechanism by which individuals can competitively participate in the outcomes of or events occurring during a show.

Thus, there is an unmet need for an improved gaming mechanism that enhances personal enjoyment of real-life events.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The invention disclosed and claimed herein, in one aspect thereof, comprises a unique gaming format, which can be, but is not required to be, played online over a computer network. In one aspect of the subject invention, it combines the thrill of auction bidding with the competitive excitement of market-based transactions in the context of any real-life event or series of events. Each game is a one-of-a-kind process where the outcome depends as much on real-life events as it does on the decisions made by the players.

The game format is centered on (i) the creation for any given Event of a Game Configuration and (ii) the creation for each Game played under a particular Game Configuration of a unique “micromarket” through the application of an initial Right allocation procedure and a subsequent open market to facilitate the exchange of Rights by players in a Game. In each game (and thus each micromarket) there are generally two different forms of value that can be held by the players: points and rights (“Rights”) to receive (or in some cases, lose) future points or Rights (herein referred to as “Dividends”) awarded based at least in part upon the occurrence of certain events (herein referred to as “Dividend Events”) during the Event that is the subject of the Game. Within the game format (and thus the micromarkets), such Rights are represented by ownership by players of all or some portion of the right to receive (or lose, as applicable) the Dividends awarded upon the occurrence of any given Dividend Event. It is within the contemplation of the subject invention that Rights in a Game can consist of rights other than rights to receive (or lose, as applicable) Dividends, which Rights could give the holder the option to take a particular action at some point during a Game. Generally, the objective is to be the player with the most points at the end of the game.

The game format utilizes structured amounts of and relationships between points, Dividends, the number of participants in the Game, the number of contestants in the underlying Event, and the number of potential unique Rights that may entitle an owner to a Dividend in the Game. Dividends are awarded upon the occurrence of Dividend Events, such as when teams or contestants win games, titles, or competitions, or advance to later rounds of the event. For example, a Game Configuration for the Event of the 2004-2005 college football season within the format, Dividends can be configured such that Dividend Events include each regular season win for a team, the winning of a conference championship, the acceptance of an invitation to a bowl game, and winning the national championship. Further, a Game Configuration for the Event of a reality television show where contestants compete for intermediate prizes and are sequentially eliminated within the format might be configured so that Dividend Events included each time a contestant won an intermediate prize and each time a contestant survived until a later elimination round in the Event. Dividend Events can be established such that upon the occurrence of a specified event a player owning the Right with respect to the Dividend Event has points deducted from his or her point total instead of being awarded points. Generally, potential Dividend Events include any event that might happen during the Event that is the subject of a particular Game Configuration and Game, and Dividend Events can configured differently for any Game Configuration with respect to any Event. Other Dividend Events can be configured in each Game Configuration.

At the outset of a Game or at one or more other points during a Game, ownership of Rights in the Game are allocated to the players in accordance with one of the procedures described more fully herein. One such procedure involves players bidding on Rights with a limited number of points allocated to them at the outset of the game in an auction in which the highest bidder for any given Right is awarded the Right. Another such procedure is random allocation. Others are described herein. In one implementation of the present invention, players in a game submit auction bids substantially simultaneously through an intuitive online auction interface. In another implementation of the present invention, Various Rights can be allocated through several initial allocation processes over the course of a Game.

Upon completion of the initial allocation of any Rights, the market phase of the game with respect to the Rights allocated commences during which Dividends are awarded to those players owning the Rights to receive them upon the occurrence of the related Dividend Events. During the market phase, players can buy and sell Rights (for points) and can trade Rights for other Rights through an interactive process. Since the objective of the game, generally, is to accumulate as many points as possible, players use their own opinions of the value of any given Right (which is in part a function of the likelihood that the Dividend Event to which the Right relates will occur) to determine how many points or what other Rights (valued accordingly) they are willing to exchange for any Right. For example, in the case a Right to receive a Dividend upon a team's winning a championship, the value of that Right would be in part a function of team's chances of success. In one implementation of the present invention, during the market phase of a Game players can submit and accept a bid, ask and trade offers substantially simultaneously through an online interface and can view the current standings in the game remotely as the Event progresses.

In another aspect of the invention, a player can configure the game software to suit their particular interests, playing styles, intensity, and competitive tastes. For example, in one implementation of the subject invention, the game can be configured so that each player is allocated a certain number of points at the beginning of each game and transactions are limited based at least in part on the amount of a player's accumulated and retained points. In another implementation of the subject invention, transactions are not limited by accumulated points.

In yet another aspect thereof, an artificial intelligence component is provided that employs a probabilistic and/or statistical-based analysis to prognose or infer an action that a user desires to be automatically performed.

To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

### BRIEF DESCRIPTION OF THE DRAWINGS

FIG. 1 illustrates a game product that facilitates auction and market-based transactions in accordance with the subject invention.

FIG. 2 illustrates a methodology of gaming that provides auction and market-based transactions in accordance with the invention.

FIG. 3 illustrates a methodology of providing points, allocation of Rights, and Dividends in accordance with the invention.

FIG. 4 illustrates a methodology of configuring timing of the initial allocations of Rights in accordance with the subject invention.

FIG. 5 illustrates a methodology of applying an open auction with limited points in accordance with the invention.

FIG. 6 illustrates a methodology of applying an open auction with unlimited points in accordance with the invention.

FIG. 7 illustrates a methodology of applying a blind auction with limited points in accordance with the invention.

FIG. 8 illustrates a methodology of applying a blind auction with unlimited points in accordance with the invention.

FIG. 9 illustrates a methodology of providing tools to assist player auction strategies in accordance with the invention.

FIG. 10 illustrates a methodology of applying proxy-style bidding in accordance with the invention.

FIG. 11 illustrates a methodology of applying Dutch auction-style bidding in accordance with the invention.

FIG. 12 illustrates a methodology of implementing market-based transactions in accordance with the invention.

FIG. 13 illustrates a methodology of managing a Game in accordance with the invention.

FIG. 14 illustrates a game system that employs artificial intelligence in accordance with the invention.

FIG. 15 illustrates a screenshot of a website home webpage of one implementation of the invention.

FIG. 16 illustrates a screenshot of a user-specific home webpage of one implementation of the invention.

FIG. 17A-C illustrates a screenshot of an informational webpage of one implementation of the invention.

FIG. 18 illustrates a screenshot of a webpage through which a user can join a Game of one implementation of the invention.

FIG. 19 illustrates a screenshot of a webpage through which a user can select from available Game Configurations a Game Configuration to use to create a Game of one implementation of the invention.

FIG. 20 illustrates a screenshot of a webpage through which a user can create a Game within a Game Configuration of one implementation of the invention.

FIG. 21A and FIG. 21B illustrate portions of a screenshot of a webpage through which a user can view Game Configuration for and other information relating to a Game of one implementation of the invention where all Rights related to each Dividend Event with respect to a team are bundled as described herein.

FIG. 22A and FIG. 22B illustrate portions of a screenshot of a webpage through which a user that is a Commissioner for a Game can view and modify certain Game Configuration options and other information relating to a Game of one implementation of the invention.

FIG. 23 illustrates a screenshot of a Game-specific home webpage of one implementation of the invention.

FIG. 24 illustrates a screenshot of an auction webpage of one implementation of the invention where all Rights related to each Dividend Event with respect to a team are bundled as described herein.

FIG. 25 illustrates a screenshot of a market webpage of one implementation of the invention where all Rights related to each Dividend Event are bundled as described herein.

FIG. 26 illustrates a screenshot of webpage through which a player can submit an offer for a direct trade of Rights with another player in accordance with one implementation of the subject invention.

FIG. 27 illustrates a screenshot of webpage through which a player can confirm submission of an offer for a direct trade of Rights with another player in accordance with one implementation of the subject invention.

FIG. 28 illustrates a screenshot of a Game-specific player summary in accordance with one implementation of the subject invention.

FIG. 29A and FIG. 29B illustrate portions of a screenshot of a webpage through which a user can view Game Configuration for and other information relating to a Game of one implementation of the invention where certain Rights related to Dividend Event with respect to certain teams competing in an Event are owned separately as described herein.

FIG. 30A and FIG. 30B illustrate portions of a screenshot of a webpage through which a user that is a Commissioner for a Game can view and modify certain Game Configuration options and other information relating to a Game of one implementation of the invention.

FIG. 31 illustrates a screenshot of a Game-specific home webpage of one implementation of the invention.

FIG. 32 illustrates a screenshot of an auction webpage of another implementation of the invention where certain Rights related to Dividend Events with respect to certain teams competing in an Event are owned separately as described herein.

FIG. 33 illustrates a screenshot of a market webpage of one implementation of the invention where certain Rights related to Dividend Events with respect to certain teams competing in an Event are owned separately as described herein.

FIG. 34 illustrates a screenshot of a webpage of one implementation of the invention that allows players to place various limitations on an offer to exchange Rights with another player.

FIG. 35 illustrates a screenshot of webpage through which a player can submit an offer for a direct trade of Rights with another player in accordance with one implementation of the subject invention.

FIG. 36 illustrates a screenshot of webpage through which a player can confirm submission of an offer for a direct trade of Rights with another player in accordance with one implementation of the subject invention.

FIG. 37 illustrates a screenshot of a Game-specific player summary in accordance with one implementation of the subject invention.

FIG. 38 illustrates a screenshot of a Game-specific Rights summary in accordance with one implementation of the subject invention.

FIG. 39 illustrates a screenshot of a value calculator webpage in accordance with one implementation of the invention.

FIG. 40 illustrates a screenshot of a webpage through which an administrator can enter Event results data in order for such data to be processed by the system in accordance with the applicable Game Configuration in accordance with one implementation of the invention.

FIG. 41 illustrates a block diagram of a computer operable to execute the disclosed architecture.

FIG. 42 illustrates a schematic block diagram of an exemplary computing environment in accordance with the subject invention.

### DETAILED DESCRIPTION OF THE INVENTION

Game Definitions

The following terms are used throughout this application, the definitions of which are provided herein to assist in understanding various aspects of the subject invention.

Auction: With respect to any particular Game and Game Configuration, a procedure that can be employed to initially allocate Rights among the Players.

Commissioner: With respect to any Game, the person that establishes the Game, selects the procedures for initial allocation of Rights and configuration options, invites Players to participate in the Game, and generally oversees administration of the Game.

Dividend: An award (or reduction) of points or Rights to a Player that owns a Right awarded at least in part upon the occurrence of a Dividend Event with respect to the Right.

Dividend Event: An event occurring at least in part within an Event upon which a Dividend is awarded to players to whom Rights with respect to such Dividend Event are allocated at least in part.

Event and real-life event (RLE): Any real-life sporting event or events, television program event or events or other event or events to which a Game played in the format of the subject invention relates. Such terms contemplate events ranging from a minor portion of a single event (for example, a quarter of a single game) to an entire season or more (for example, an entire season of a professional football including the playoffs, or a combination of a season of professional football with a season of professional basketball or some other event) and could include the regular season or any portion thereof, the playoffs, or both, for virtually any competitive event related to, for example, football, basketball, baseball, soccer, hockey, golf, car racing, any other professional or amateur sports, reality-based television program, competition, or the like, as well as any other event external to a Game with at least some measurable results, including a fantasy event that is driven by a pseudo-random number generator or the like.

Game: Any tournament or competition entered into by particular Players with respect to a particular Event within a particular Game Configuration.

Game Configuration: The set of values established for Games with respect to an Event, as more particularly described herein.

Market: With respect to any particular Game, the interactive process through which Players are able to buy, sell and trade Rights.

Market Phase: With respect to any particular Right, the portion of a Game following the initial allocation of such Right during which Dividends with respect to such Right may be awarded and players are able to buy, sell and trade Teams in the related Market.

Owner: With respect to any Right at any time, the Player or Players owning such Right at such time.

Player: Any participant in a Game.

Right: The right to receive a Dividend upon the occurrence of the related Dividend Event or any other right identified as such within a Game Configuration other than rights to receive Dividends, which Rights could, for example, give the holder the option to take a particular action at some point during a Game.

General Definitions

The invention is now described with reference to the drawings, wherein like reference numerals are used to refer to like elements throughout. In the following description, for purposes of explanation, numerous specific details are set forth in order to provide a thorough understanding of the subject invention. It may be evident, however, that the invention can be practiced without these specific details. In other instances, well-known structures and devices are shown in block diagram form in order to facilitate describing the invention.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

While certain ways of displaying information to users are shown and described with respect to certain figures, those skilled in the relevant art will recognize that various other alternatives can be employed. The terms “screen,” “web page,” and “page” are generally used interchangeably herein. The pages or screens are stored and/or transmitted as display descriptions, as graphical user interfaces, or by other methods of depicting information on a screen (whether personal computer, PDA, mobile telephone, or other suitable device, for example) where the layout and information or content to be displayed on the page is stored in memory, database, or another storage facility.

While, for purposes of simplicity of explanation, the one or more methodologies shown herein, e.g., in the form of a flow chart, are shown and described as a series of acts, it is to be understood and appreciated that the subject invention is not limited by the order of acts, as some acts may, in accordance with the invention, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the invention.

The Game Format

The disclosed gaming format provides a unique fantasy gaming format. In one implementation thereof, it combines the thrill of auction bidding with the competitive excitement of market-based transactions in the context of any event or series of events. The game format combines the capability of auctions and market-based transactions in association with a real-life event or events, such as found in association with sporting events and television programs. Note that the terms “Event”, “RLE” and “real-life event” are used interchangeably herein to refer to the real-life event or events to which a game played in the format relates and that such events to which a game relates can range from a minor portion of a single event (for example, a quarter of a single game) to an entire season or more (for example, an entire season of a professional football including the playoffs, or a combination of a season of professional football with a season of professional basketball or some other event).

Potential RLEs include the regular season or any portion thereof, the playoffs, or both, for virtually any competitive event related to, for example, football, basketball, baseball, soccer, hockey, golf, car racing, any other professional or amateur sports, reality-based television program, competition, or the like, as well as any event external to the game with at least some measurable results. Note that although the concept of an Event heretofore has been described as a real-life event, it is to be appreciated that an Event can be a fantasy event that is driven by a pseudo-random number generator or the like. Thus, an Event does not need to consist of results of independent real-life actors, and may consist of a technologically- or computer-generated program or event. Note that the term Dividend Event used herein has a different meaning from the terms “Event”, “RLE” and “real-life event” as set forth herein.

In addition to the applicability to popular domains such as football and baseball, the game format can be applied to a broad variety of participants' particular interests and can be configured to suit participants' particular playing styles, intensity, and competitive tastes. The skills necessary for success in any Game include an understanding not only of the related RLE, but also of the playing characteristics of the other players in the Game.

As one implementation of the subject invention involves providing an interactive online experience, unregistered non-participating viewers can be referred to an interactive website (e.g., an actual gaming server site, or a different website) for a better understanding of how some of the features described herein are brought to life, and for playing the associated games. Moreover, such unregistered non-participating viewers can be provided read-only snapshots of certain aspects of ongoing Games in order to provide a better understanding as to how Games within the format are played and further, as an enticement to join in future Games. Filtering can be applied by a site administrator to limit the type and amount of information that can be exposed to non-participating viewers.

It is further within contemplation of the subject invention that registered or unregistered non-participating viewers can be allowed more access (for a fee, for example) such that they can watch and/or check the status of game play as an RLE progresses.

A goal of the game format is to provide a fun and exciting experience in and of itself that also enhances participants' enjoyment associated with the RLE that is the subject of a Game. Note that the game format product described herein supports a plurality of game configurations that can be ongoing at any given time. For example, a first configuration can be associated with an ongoing college football season, a second configuration can be associated with an ongoing professional hockey season, and a third configuration can be associated with an ongoing television series, each of which can have defined and distinct beginning and ending times.

Additionally, the game format product described herein supports a plurality of games within any particular game configuration. For example, 1,000 participants involved in a game configuration relating to a particular Event (for example, a college football season) might be separated into 100 different games involving on average 10 players each (although any given game could have more or less than 10 players). As generally defined herein, a game is any tournament or competition, as configured in the game format within a particular game configuration, which is entered into by a player with respect to a particular Event. A team is any individual participant or contestant or group of participants or contestants in the Event related to a game.

The game format is centered on (i) the creation for any given Event of a Game Configuration and (ii) the creation for each Game played under a particular Game Configuration of a unique “micromarket” through the application of an initial Right allocation procedure and a subsequent open market to facilitate the exchange of Rights by players in a Game. In each game (and thus each micromarket) there are generally two different forms of value that can be held by the players: points and rights (“Rights”) to receive (or in some cases, lose) future points or Rights (herein referred to as “Dividends”) awarded based at least in part upon the occurrence of certain events (herein referred to as “Dividend Events”) occurring at least in part during the Event that is the subject of the Game. Within the game format (and thus the micromarkets), such Rights are represented by ownership by players of all or some portion of the right to receive (or lose, as applicable) the Dividends awarded upon the occurrence of any given Dividend Event. Dividend Events can be established such that upon the occurrence of a specified event a player owning the Right with respect to the Dividend Event has points deducted from his or her point total instead of being awarded points. It is within the contemplation of the subject invention that Rights in a Game can consist of rights other than rights to receive (or lose, as applicable) Dividends, which Rights could give the holder the option to take a particular action at some point during a Game.

Additionally, it is within the contemplation of the subject invention that the right to receive a Dividend awarded at least in part upon the occurrence of any given Dividend Event can be divided into one or more portions (or “shares”), with each such portion constituting an individual Right as described herein. For example, the right to receive a Dividend upon a particular team winning a championship in an Event might be divided into 10 shares, with each such share representing a Right to receive one-tenth of the Dividend awarded if such Dividend Event occurred. Note that as described herein, with respect to any Right in any Dividend at any time, an owner is the player owning or holding or having allocated to him or her such Right in such Dividend at such time. Generally, the objective is to be the player with the most points at the end of the game.

Each Game Configuration within the game format utilizes structured amounts of and relationships between points, Dividends, the number of participants in the Game, the number of contestants in the underlying Event, and the number of potential unique Rights that may entitle an owner to a Dividend in the Game. Dividends are awarded upon the occurrence of Dividend Events, such as when teams or contestants win games, titles, or competitions, or advance to later rounds of the event. For example, a Game Configuration for the Event of the 2004-2005 college football season within the format might be configured so that Dividend Events included each regular season win for a team, the winning of a conference championship, the acceptance of an invitation to a bowl game, and winning the national championship.

Further, a Game Configuration for the Event of a reality television show where contestants compete for intermediate prizes and are sequentially eliminated within the format might be configured so that Dividend Events included each time a contestant won an intermediate prize and each time a contestant survived until a later elimination round in the Event. Dividend Events can be established such that upon the occurrence of a specified event a player owning the Right with respect to the Dividend Event has points deducted from his or her point total instead of being awarded points. Generally, potential Dividend Events include any event that might happen during the Event that is the subject of a particular Game Configuration and Game, and Dividend Events can be configured differently for any Game Configuration with respect to any Event. Other Dividend Events can be configured in each Game Configuration.

At the outset of a Game or at one or more other points during a Game, ownership of Rights in Game are allocated to the players in accordance with one of the procedures described more fully herein. One such procedure involves players bidding on Rights with a limited number of points allocated to them at the outset of the game in an Auction in which the highest bidder for any given Right is awarded the Right. Another such procedure is random allocation. Others are described herein. In one implementation of the present invention, players in a game submit auction bids substantially simultaneously through an intuitive online auction interface. In another implementation of the present invention, various Rights can be allocated through several initial allocation processes over the course of a Game.

Upon completion of the initial allocation of any Rights, the market phase of the Game with respect to those Rights commences during which Dividends are awarded to those players owning the Rights to receive them upon the occurrence of the related Dividend Events. During the market phase, players can buy and sell Rights (for points) and can trade Rights for other Rights through an interactive process. Since the objective of the game is to accumulate as many points as possible, players use their own opinions of the value of any given Right (which is in part a function of the likelihood that the Dividend Events to which the Right relates will occur) to determine how many points or what other Rights (valued accordingly) they are willing to exchange for any Right. For example, in the case a Right to receive a Dividend upon a team's winning a championship, the value of that Right would be in part a function of team's chances of success. Specific features of the present invention relating to the market phase of the game format are described herein.

In one implementation of the present invention, during the market phase, players in a Game can submit and accept bid, ask and trade offers substantially simultaneously through an online interface and can view the current standings in the Game remotely as the Event progresses through online presentation. In another implementation of the present invention, Game information is managed and presented and initial allocations of Rights, exchanges of Rights and Dividend awards are processed through an online user interface linked to automated database processing.

In a typical implementation of the present invention, a Game Configuration for a particular Event is configured as described herein and made available. Any individual can create a Game with respect to such Event within such Game Configuration and can choose from among the various procedures described herein for purposes of determining the initial allocation of Rights and from among the various features described herein relating to the market phase of the Game. Such individual can be referred to as the “Commissioner” for the Game. The Commissioner of each Game can invite other players to participate in the game and generally oversees administration of the game.

In one implementation of the invention, the administrative responsibilities of the Commissioner are largely automated through software or otherwise; for example, an automatically-generated email invitation can be sent to invitees and Game information can be processed through an online user interface linked to automated database processing, as described more fully herein. Players participate in the procedure selected by the Commissioner to be used to determine the initial allocation of Rights and thereafter in the market phase. Following the initial allocation of any particular Right, Dividends are awarded to the owner of the Right upon the occurrence of a Dividend Event related to the Right. Generally, the objective of each Game is to be the player with the most points at the end of the RLE. A simplified example of a Game is described in detail infra. Several variations on this format are also described herein.

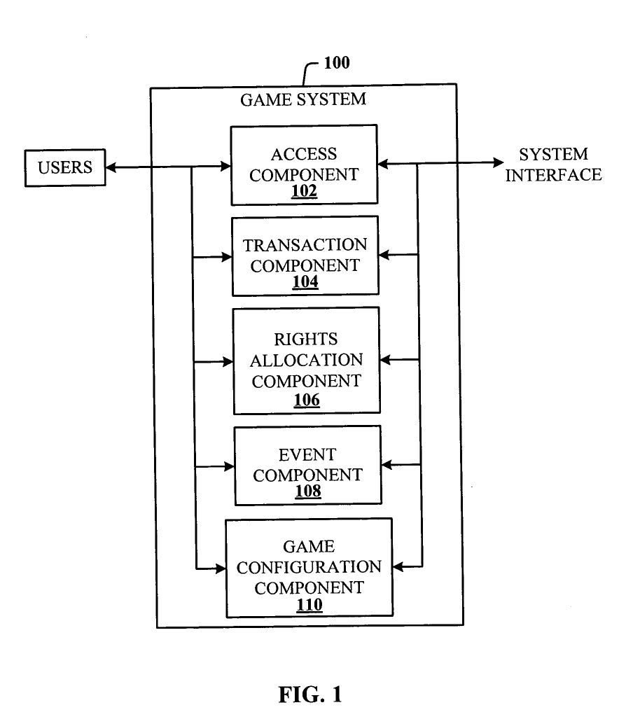

Referring now to FIG. 1, there is illustrated a game system product 100 (that could be implemented in the form of either hardware or software or some other means) that facilitates initial Right allocations and market phase transactions in accordance with the subject invention. The game system 100 allows a plurality of players to join a Game and play competitively against each other. The game system 100 can be in the form of software hosted on a network-based server such that access by the players can be made remotely from substantially everywhere. An access component 102 of the system 100 facilitates multi-user access to the system by way of a user interface, for example an Internet based browser graphical user interface (GUI). Screenshots of certain aspects of a GUI that facilitate user interaction with respect to signing in, activation, auctions, transactions, event status information, and player standings, for example, are provided infra.

The game system 100 also includes a transaction component 104 that facilitates market phase transactions and the processing thereof in accordance with the subject invention such as a buying, selling, and/or trading Rights related to the RLE. In one implementation, the transaction component 104 can be in the form of software hosted on a network based server. Certain features that can be made available as part of the market component are described herein.

A Rights allocation component 106 facilitates the initial allocation of Rights in a Game to the players in the Game and the processing thereof in accordance with the subject invention. As described herein, the procedure for allocating Rights in a Game initially can be random or one of the several auction procedures described herein. It is to be appreciated that any type of auction can be implemented to facilitate initial allocations of Rights in a Game, in accordance with the invention.

An event component 108 facilitates Event data input and processing, for example, of Dividend Events. The Event data can be input manually and/or automatically. In one implementation, automatic Event data input can occur via a system interface to a communications network (e.g., the Internet), such that a server or website or other source offering data associated with the particular Event presents updated data that can be polled or downloaded to the event component 108 and processed and integrated into the game system 100. A game configuration component 110 facilitates configuration and setup of a Game by an administrator, called herein, a Commissioner. In the case of the game system 100 being implemented through software, the Commissioner (or administrator) can also access the game system 100 remotely and/or locally to ensure configuration and proper operation of the one or more Games.

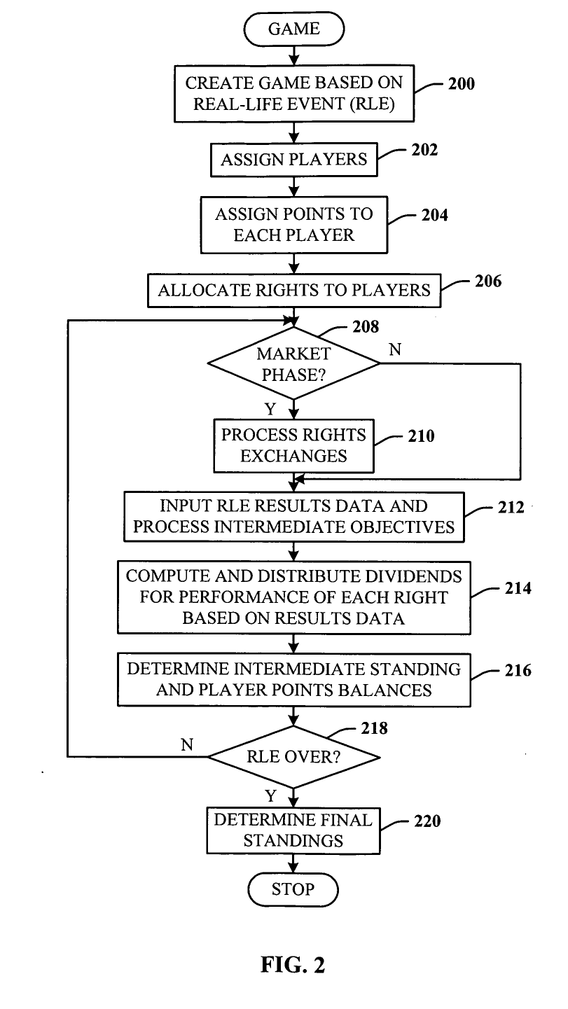

FIG. 2 illustrates a methodology of gaming that provides auction and market-based transactions in accordance with the invention. At 200, a game is created within the game system that is based on an RLE. At 202, players are assigned to the game. At 204, each of the players is assigned points with which to play the game. At 206, an initial allocation of Rights is performed so that the players can bid to purchase Rights associated with the RLE. The initial allocation of all Rights may be completed before the start of the RLE. Note, however, that it is within contemplation of the subject invention that initial allocations of Rights can occur through the start of the RLE, during the RLE, and even after the RLE has ended, in combination with certain restrictions.

At 208, it is determined whether to enter the market phase. If so, the program proceeds to 210, where Rights transactions can be performed, e.g., buy, sell, or exchange. At 212, results and data associated with the RLE are input to the game system, as well as any data and results related to Rights or Dividends. At 214, Dividends are computed and distributed for performance of each Right based on the RLE results. At 216, intermediate standing and player point balances are determined and announced. At 218, it is determined if the RLE is over. If not, flow proceeds back to 208 to continue the market phase. If, however, the RLE is over, indicating that the game is over, final standings are determined, and the standings are announced at 220. If, at 208, the market phase is not commenced, flow is to 212 to input the data and results, as before.

Game Configuration

As mentioned herein, an important element of the game format of the subject invention is the establishment for any given Event of a Game Configuration for Games played with respect to that Event. In each Game there are generally two different forms of value that can be held by the players: points, and Rights to receive Dividends awarded upon the occurrence of certain Dividend Events during the Event that is the subject of the Game. Within the game format, such Rights are represented by ownership by players of all or some portion of the right to receive the Dividends awarded at least in part based upon the occurrence of any given Dividend Event. A Dividend award (or loss, as applicable) can be effective as of a time before, at or after the occurrence of the related Dividend Event in accordance with a Game Configuration. Note that as described herein, with respect to any Right in any Dividend at any time, an owner is the player owning such Right in such Dividend at such time. It is within the contemplation of the subject invention that Rights in a Game can consist of rights other than rights to receive Dividends, which Rights could give the holder the option to take a particular action at some point during a Game. Generally, the objective of each Game is to accumulate as many points as possible during the Game. As described herein, it is within the contemplation of the subject invention that other objectives or formats that are obvious to one skilled in the art may be used to determine the results of any Game.

Each Game Configuration within the game format utilizes structured amounts of and relationships between points, Dividends, the number of participants in the Game, the number of contestants in the underlying Event, and the number of potential unique Rights that may entitle an owner to a Dividend in the Game. The primary components of each Game Configuration are (i) establishment of Dividend Events and Dividend amounts and (ii) establishment of point allocations for players participating in Games where a limited points auction format, as described herein, applies.

Potential Dividend Events include any measurable occurrence that might take place at least in part during an Event, for example when teams or contestants win games, titles, or competitions, or advance to later rounds of the event. For example, a Game Configuration for the Event of the 2004-2005 college football season within the format might be configured so that Dividend Events included each regular season win for a team, the winning a conference championship, the acceptance of an invitation to a bowl game, and winning the national championship. In one implementation, those events would be Dividend Events upon the occurrence of any of them with respect to each team participating in the Event. Further, a Game Configuration within the format for the Event of a reality television show where contestants compete for intermediate prizes and are sequentially eliminated can be configured so that Dividend Events include each time a contestant wins an intermediate prize and each time a contestant advances to a later elimination round in the Event.

By way of further example, a Game Configuration for an Event including a boxing match could include Dividend Events relating to the scoring in any round or the round in which the bout ends, among others, and a Game Configuration for an Event involving a football game could include Dividend Events relating to various achievements by individual players, for example, scoring a touchdown or making an interception. Generally, potential Dividend Events include any event that might happen during the Event that is the subject of a particular Game Configuration and Game, and Dividend Events can be configured differently for any Game Configuration with respect to any Event.

In addition, Dividend Events can be established such that upon the occurrence of a specified event a player owning the Right with respect to the Dividend Event has points deducted from his or her point total or Rights removed (or deallocated) from his or her portfolio, instead of the player being awarded points or Rights. For example, in a given Game Configuration Dividend Events could be established such that a Dividend of a certain number of points is awarded upon the occurrence of a team's winning a game and a certain number of points is taken away upon the occurrence of a team's losing a game, in each case to or from the owner of the related Rights.

The establishment of Dividend Events and Dividends for a Game Configuration for an Event is guided by several factors and can be structured to achieve a variety of game experience objectives. For example, in a Game Configuration for an Event consisting of the entire 2004-2005 Division I college basketball season and the post-season conference and NCAA tournaments, Dividend Events might include each time a team wins a game, each time a team advances to a particular level of the NCAA tournament and a team winning its conference tournament or the NCAA tournament. The amount of the Dividends awarded for each of the Dividend Events can be the same or different. For example, the amount of the Dividend awarded for a team winning a regular season game might be less than the amount of the Dividend awarded for a team winning the NCAA tournament, and maybe substantially so.

Dividend Events and Dividend amounts can be configured to specific levels of relative importance. For example, one Game Configuration including relatively high amounts for Dividends related to post-season Dividend Events would elevate the importance of post-season competition for Games played under that Game Configuration, while another Game Configuration including relatively high amounts for Dividends related to regular season Dividend Events would elevate the importance of regular season competition for Games played under that Game Configuration. Similar objectives can be achieved by increasing or decreasing the number or type of Dividend Events within a Game Configuration. Generally, Dividend Events and Dividend amounts within Game Configurations are expected to be structured in a variety of manners that stimulate competition within Games and enjoyment by the players.

For Games in which a limited points auction format, as described herein, applies, in addition to the establishment Dividend Events and Dividend amounts, a Game Configuration can establish initial point allocations for players participating in Games within the Game Configuration. A Game Configuration can include varying levels of initial point allocations depending on the number of players in a Game and the time relative to the progress of the Event at which the initial allocation of Rights, as described herein, is finalized. As with establishment of Dividend Events and Dividend amounts, the amount of the initial point allocations influences the gaming experience and player strategy for Games within a Game Configuration. For example, the aggregate amount of points initially allocated to all players in a Game will bear some relationship to the aggregate amount of Dividends expected to be awarded in the Game. In one implementation of the present invention, the relationship between those amounts can be that they are equivalent or approximately equivalent; in another implementation, the amounts can differ substantially.

Another relationship that is dependent on the initial point allocations is the relationship between the amount of points initially allocated to a given player and the maximum amount of Dividends that can be awarded pursuant to any particular Right.

Variation of these relationships (which are of course also affected by the applicable Dividend Events and Dividend amounts) permits the creation of different scenarios and situations that make individual Games unique and encourage competitive development of appropriate alternative game strategies. Multiple Game Configurations can be made available for any Event in order to permit players to select the configuration that best suits their tastes and interests.

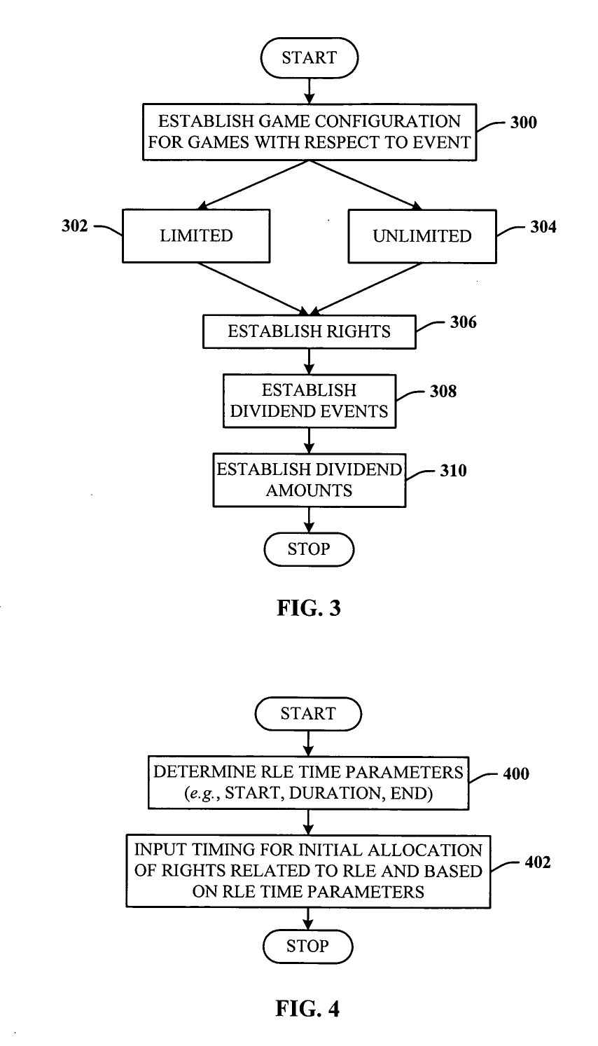

FIG. 3 illustrates a methodology of creating a Game Configuration in accordance with the invention. At 300, a Game Configuration with respect to an Event providing Rights, Dividend amounts, Dividend Events, and initial points allocation is established. In another implementation, optionality is available to the Commissioner to select from within a Game Configuration the Rights, Dividend amounts, Dividend Events, and initial point allocations that will apply for a given Game. At 302, a limited points game is provided, potentially with initial point allocation and Dividend amounts varying with the number of participants in a Game, and at 304, an unlimited points game is provided. In limited points format, each player is initially allocated a certain number of points, and this limited number of points can be used to bid on Rights during the initial allocation of Rights. The points can also be used for exchanges in the market phase, and remain part of the player balance if unspent at the end of the RLE. A variation on the standard format is for players to participate in the auction with unlimited points. Commissioners can be provided the option of choosing to allow limited points or unlimited points in any game. Initial allocations of Rights and limited and unlimited points configuration options are described more fully herein.

At 306, Rights are established. At 308, Dividend Events are established. At 310, Dividend amounts are established. Dividend awards are generally issued based upon the occurrence with respect to a Right of a Dividend Event, such as a team's achievement of certain pre-specified accomplishments that vary from Event to Event. For example, Dividend awards can be made for each victory or for each victory where the margin of victory is greater than some fixed amount, or where an opponent is shut out.

The subject invention contemplates that within any Game Configuration there can be several Rights with respect to any particular Dividend awarded in connection with any particular Dividend Event. Generally, in such a situation, the holder of each Right would receive a pro rata portion of the Dividend awarded in the proportion that the amount of such holder's Rights bears to all of the Rights with respect to such Dividend. For example, if with a Game Configuration for a Game there were 10 Rights allocated with respect to a Divided awarded upon the occurrence of a Dividend Event, if a player owned 3 such Rights (or shares), the player would be entitled to 30% of the Dividend awarded if the Dividend Event occurred. Other allocations of Rights and proportional and disproportional awards of Dividends are contemplated by the subject invention as will be obvious to one of ordinary skill in the art.

Although as described herein in one implementation of the subject invention the objective of a Game is to be the player with the most points at the end of the Game, the subject invention also contemplates that a Game Configuration can be established such that other objectives are established at least in part. For example, in one implementation of the subject invention, the standings at any point during a Game can result in an allocation of points or Rights at least in part in a relative manner such that players with higher or lower standings are allocated more or less points or Rights.

Another Game Configuration can be established such that players in a Game are grouped into teams with objectives configured at least in part on the basis of the outcomes of the Game for all the players on each of the teams.

In another implementation of the subject invention, a Game Configuration can be established such that a player's success in a Game is measured at least in part by reference to such player's Dividend results over some interval in the Game as compared to the Dividend results of one or more other players in the Game. Thus, for example, a Game Configuration can specify that a Dividend Event can occur if Player X accumulates more Dividends over the course of a given week than Player Y. Typically, the Rights with respect to this type of Dividend Event would be held by the player whose results satisfy the requirements of the Dividend Event criteria, although this is not required.

In yet another implementation of the subject invention, a Game Configuration can be established such that a player's continued eligibility for participation in a Game can be conditioned at least in part on the player's satisfying certain intermediate criteria. Thus, for example, a Game Configuration can specify that only players that have accumulated a certain number of points over any particular interval within a Game are eligible to continue to participate in the Game.

Initial Allocation of Rights

At the outset of a Game or at one or more other points during a Game, ownership of Rights in the Game can be allocated to the players in accordance with one of the procedures described more fully herein. One such procedure involves players bidding on Rights in an Auction in which the highest bidder for any given Right is awarded the Right. Another such procedure is random allocation. Others are described herein. In one implementation of the present invention, players in a Game submit auction bids substantially simultaneously through an online auction interface. In another implementation of the present invention, various Rights can be allocated through several initial allocation processes over the course of a Game.

It is within the contemplation of the subject invention that a Right can be allocated through the procedures described herein independently of other Rights and that Rights with respect to one or more Dividends and Dividend Events can be aggregated and allocated through a single procedure. For example, a Right to receive a Dividend upon the occurrence of a Dividend Event such as a team winning a single, specific game in a regular season can be allocated through a separate procedure than that used to allocate the Right to receive a Dividend upon the occurrence of the team's winning the immediately succeeding game. Likewise, the Rights to receive Dividends each time a team wins any regular season game and any Rights to receive any other Dividends upon the occurrence of any Dividend Event with respect to such team's performance in the Event can be allocated through a single procedure.

The subject invention provides several procedures that can be applied to determine the initial allocations of any Rights among the players with respect to Dividends. In one implementation, the procedure to be used for a Game can be given for a particular Game Configuration; in another implementation, players and/or Commissioners can be permitted to select the procedure to apply to a particular Game from among all or some of the different versions described herein and permitted by the Game Configuration. Generally, such procedures fall into two categories: auction-based procedures and non-auction based procedures. Whatever procedure is employed, the initial allocation of Rights is one of the fundamental elements of the subject invention and plays a critical role of dynamically setting the chances of any particular player winning, subject to the events within the Event.

As mentioned above, the subject invention contemplates that Game Commissioners can have the ability to select the timing of the initial allocation of Rights. FIG. 4 illustrates a methodology of configuring timing of the initial allocation of Rights in accordance with the subject invention. A noteworthy feature of the game system format is the flexibility afforded to a Commissioner to fix the timing of the beginning and the end of the initial allocation of Rights for any Game, or for any particular Right. The initial allocation with respect to any Right can be configured to end before, during, or after the time duration stipulated for a particular RLE, and generally, at any time prior to the end of the RLE. In one implementation, the initial allocation of a Right occurs prior to the time at which no event that is a potential Dividend Event with respect to such Right can occur. In another implementation, the initial allocations for several different Rights can occur at one or more points over the course of a Game. Accordingly, at 400, the Commissioner determines the RLE time parameters associated with the RLE, e.g., start, duration, end, and post-RLE activities that can be made part of the Game. At 402, initial allocation of Rights timing data is input that is related to the RLE and based on the RLE time parameters.

Auction-Based Procedures for Initial Allocation of Rights

As described above, under implementations of the present invention, the initial allocation of Rights in any Game can be made pursuant to auction-based procedures in accordance with a Game Configuration. Specific elements of several auction procedures are described below. Generally, auction procedures include an auction mode (e.g., open auction mode and blind auction mode), and set of configuration options (e.g., limited points and unlimited points), and certain other elements (e.g., proxy-style bidding or “Dutch” auction capability). Generally, auction-based procedures for initial allocation of rights involve players submitting bids on Rights with points, with each Right allocated to the high bidder at the end of the auction. In one implementation of the subject invention, the auctions with respect to each of the Rights in a Game Configuration within a game occur substantially simultaneously, with each Right available for allocation auctioned through a single interactive display format where information on all available Rights is presented and processed substantially simultaneously. No two auctions are necessarily the same. In one implementation of the subject invention, auction bidding and processing occurs through the facility of an interactive computer-network based user interface.

The subject invention contemplates that, in one implementation, the auction procedure to be used for a Game can be given for a particular Game Configuration; in another implementation, players and/or Commissioners can be permitted to select the procedure to apply to a particular Game from among all or some of the different versions described herein and permitted by the Game Configuration. As mentioned supra, one auction mode in the game system format is the open auction mode with limited points. Others include the blind auction mode and other configuration options. The auction mode and configuration options chosen have a significant impact on the Game and auction experience and strategy. The best auction mode and configuration options for any Game depend upon the preferences of the players in that Game. Several auction modes and related configuration options are described infra. Other auction formats and procedures as obvious to one skilled in the art are contemplated by the subject invention.

Open Auction Mode

In one implementation of the subject invention, the auction procedure can be configured so that during an Auction the high bid for each Right being allocated in the Auction is available (including through an online user interface) to each of the players. This implementation is referred to as the open auction mode. In the open auction mode, a mechanism is employed to accept and process bids for each Right from the players and to display or otherwise make available to the players in the Game the highest bid for each Right while the Auction is in progress and, when the Auction for any Right ends, the Right is allocated to the player with the highest bid. As described herein, it is within the contemplation of the subject invention that the right to receive a Dividend with respect to any Dividend Event can be divided into portions or shares, each of which might constitute a Right in and of itself and each of which might be the subject of separate auction bidding processes and allocated in accordance with the results thereof and as described herein.

In one implementation of the subject invention the open auction mode can be configured so that each player is allocated a predetermined, limited (i.e., finite) number of points in accordance with the applicable Game Configuration and Game with which to bid on Rights in the auction. This implementation is referred to as the limited points configuration option and is also available as described herein in connection with a Game employing a blind auction mode. In the limited points configuration option, during an open auction players place bids on Rights with points which are deducted from the player's balance as long as a bid is the highest bid for a Right, and the aggregate amount of a player's currently winning (i.e., high) bids can never exceed the amount of points originally allocated to that player. That is, a player's point balance can never be negative. Bids that are not high bids at any given time are discarded and the points bid in a discarded bid are restored to the player's available balance. Additional bids can be continuously and simultaneously input by players, processed by the game system and updated and presented within the time set for auction. Under certain circumstances described herein, the Auction for any particular Right can be extended.

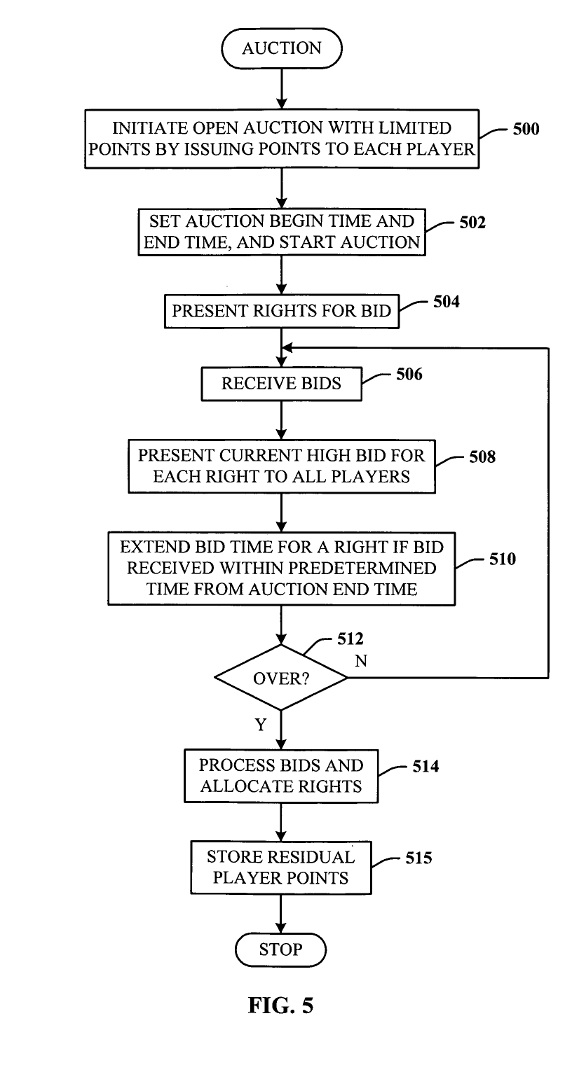

FIG. 5 illustrates a methodology of applying an open auction mode with limited points configuration in accordance with the invention for purposes of initially allocating Rights. At 500, open auction mode is initiated with limited points. At 502, the auction begin time and end time are input, and the auction is commenced. At 504, the Rights are selected and presented to the players for bid. At 506, bids are received. At 508, the current high bids are made available to players for all Rights being allocated in the auction. At 510, the bid time for a Right can be extended beyond the previously set auction time if a bid received is within a predetermined time before the scheduled end time of the auction for a team. At 512, it is determined if the auction is over. If not, flow is back to 506, to continue to receive and process bids. If the auction for that Right is over, flow is to 514, where bids are processed and Rights are allocated. Note that although not shown, the market phase with respect to Rights can occur following the auction. This is described in greater detail hereinbelow. At 516, any residual points that exist in a player account at the close of the auction are retained in the player account.

In one implementation of the subject invention the open auction mode can be configured so that each player can submit bids for Rights in the Auction with an unlimited (i.e., infinite) number of points. This implementation is referred to as the unlimited points configuration option and is also available as described herein in connection with a Game employing a blind auction mode. In the unlimited points configuration option, each player can submit bids for Rights in the Auction without regard to any point limitation. Under certain circumstances, other limitation on Rights, such as the number or percentage of Rights that may be owned by any single player, can be incorporated into the bid processing. Additional bids are continuously input by players, updated, and presented within the time set for auction. Under certain circumstances described herein, the Auction for any particular Right can be extended. Rights are allocated to the high bidder, subject to any limitations as described herein.

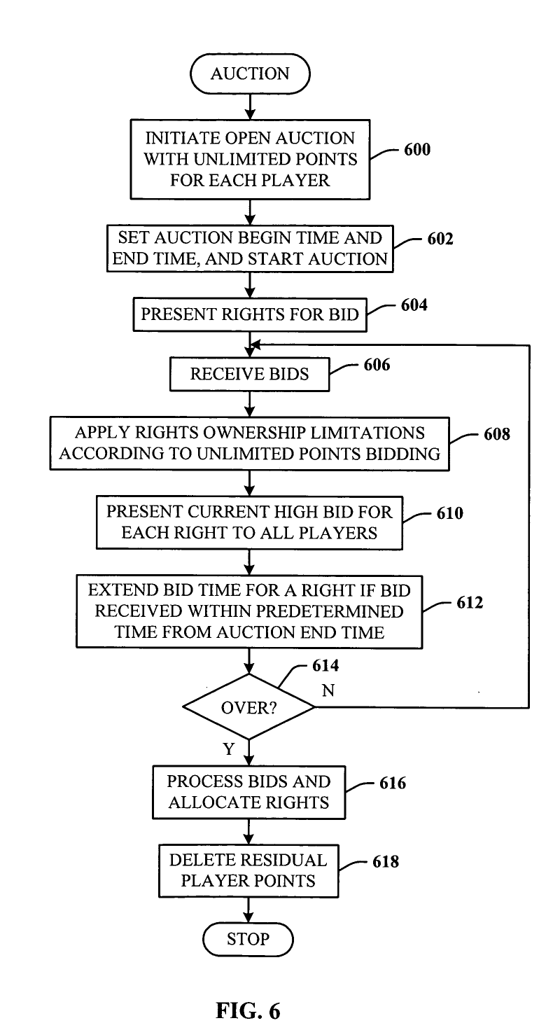

Accordingly, FIG. 6 illustrates a methodology of applying an open auction mode with unlimited points configuration in accordance with the invention for purposes of initially allocating Rights. At 600, open auction mode is initiated with unlimited points for each player. At 602, the auction begin time and end time are input, and the auction is commenced. At 604, the Rights are selected and presented to the players for bid. At 606, bids are received. In auctions using unlimited points configuration, a player can be limited to a percentage of ownership of Right with respect to a Dividend or a number of Rights during an RLE or otherwise in accordance with a Game Configuration. Accordingly, at 608, the system evaluates the validity of a bid given applicable limitations in accordance with the applicable Game Configuration.

At 610, the current high bids for each Right are made available to all players for all Rights in the Auction. At 612, the bid time for a Right can be extended beyond the previously set auction time if a bid received is within a predetermined time before the scheduled end time of the auction for a Right. At 614, a determination is made as to whether the auction is over. Note that although not shown, the market phase can occur following the auction. This is described in greater detail hereinbelow. If the auction is not over, flow is back to 606 to continue to receive and process bids. When the auction ends, as determined at 614, bids are processed and Rights are allocated, as indicated at 616. At 618, residual points of a player are then deleted.

Blind Auction Mode

In another implementation of the subject invention, the auction procedure can be configured so that during an Auction the high bid for each Right being allocated in the Auction is not available to all of the players (although the high bid for any given Right can be made available to one or more of the players in accordance with a Game Configuration). This implementation is referred to as the blind auction mode. In the blind auction mode, a mechanism is employed to accept and process bids for each Right from the players and to display or otherwise make available to only certain players in the Game the highest bid for each Right while the Auction is in progress and, when the Auction for any Right ends, the Right is allocated to the player with the highest bid. As described herein, it is within the contemplation of the subject invention that the right to receive a Dividend with respect to any Dividend Event can be divided into portions or shares, each of which might constitute a Right in and of itself and each of which might be the subject of separate auction bidding processes and allocated in accordance with the results thereof and as described herein.

In one implementation of the subject invention the blind auction mode can be configured so that each player is allocated a predetermined, limited (i.e., finite) number of points in accordance with the applicable Game Configuration and Game with which to bid on Rights in the auction. This implementation is referred to as the limited points configuration option and is also available as described herein in connection with a Game employing an open auction mode, with some modifications. In the limited points configuration option, during a blind auction players place bids on Rights with points; however, rather than being limited to having high bids at any given time that do not exceed the points allocated to the player (as in the open auction mode with limited points configuration), bids that cannot be satisfied from the player's point allocation are modified, as described infra.

Another difference between this configuration option and the limited points configuration option in the open auction mode, is that bids that are not high bids at any given time are not discarded, but are retained and processed as described herein. Additional bids can be continuously and simultaneously input by players, processed by the game system and updated and presented within the time set for auction. Under certain circumstances described herein, the Auction for any particular Right can be extended. The processing for this type of Auction is based at least in part on bid amounts and generally occurs as follows. The Right with the highest bid will be allocated to the player placing the bid. The points bid will be deducted from the player's balance. Any of that player's remaining bids that exceed the player's remaining point balance are automatically reduced to the amount of that balance. The processing proceeds to the Right with the next highest bid and so on until all Rights are allocated or all bids are processed. It is contemplated that the processing of allocation of Rights and bids in the blind auction mode with limited point configuration can occur in some other order in accordance with a Game Configuration

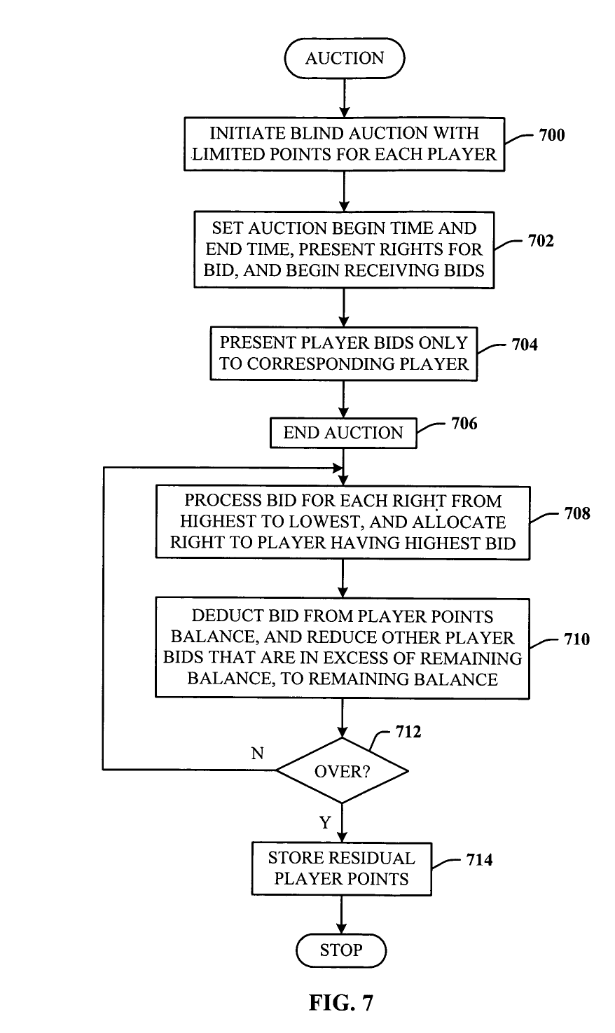

FIG. 7 illustrates a methodology of applying a blind auction mode with limited points configuration in accordance with the invention for purposes of initially allocating Rights. At 700, he blind auction mode is initiated with limited points for each player. At 702, the auction begin time and end time is set, and Rights are presented for each player to see. However, at 704, no other player bid is presented to a given player. Each player sees only his or her bids. At 706, the auction ends. At 708, the bids are processed for each Right from the highest to the lowest as described herein and allocated to the player with the highest bid. Any other bid of that player in excess of the remaining balance is automatically reduced to the remaining balance, as indicated at 710. At 712, if there are any unallocated Rights with outstanding bids, the bids for the Rights with the next highest bid will then be processed in a similar manner until all bids are processed, by returning to 708. If there are no unallocated Rights with outstanding bids, at 714, any residual points are then stored in the player account for later use (e.g., the market phase).

In another implementation of the subject invention, the blind auction mode with limited points configuration contemplates that bids will be processed similarly to the methodology described herein for the open auction mode with limited points configuration; that is, with immediate bid processing and a limitation on the aggregate amount of high bids that any player can have at any given time.

In another implementation of the subject invention the blind auction mode can be configured so that each player can submit bids for Rights in the Auction with an unlimited (i.e., infinite) number of points. This implementation is referred to as the unlimited points configuration option and is also available as described herein in connection with a Game employing an open auction mode, with some modifications. In the unlimited points configuration option, each player may submit bids for Rights in the Auction without regard to any point limitation. Additional bids are continuously input by players, updated, and presented within the time set for auction. Under certain circumstances described herein, the Auction for any particular Right can be extended.

In the limited points configuration option, during a blind auction players place bids on Rights without regard to any point limitation. Players are not able to see any other players' bids for any Right. Under certain circumstances, other limitations on Rights, such as the number or percentage of Rights that may be owned by any single player, can be incorporated into the bid processing. When the auction for a Right ends, the bids are processed for each team from the highest to the lowest, subject to any limitation as described in the preceding sentence. Additional bids can be continuously and simultaneously input by players, processed by the system and updated and presented within the time set for auction. Under certain circumstances described herein, the Auction for any particular Right can be extended.

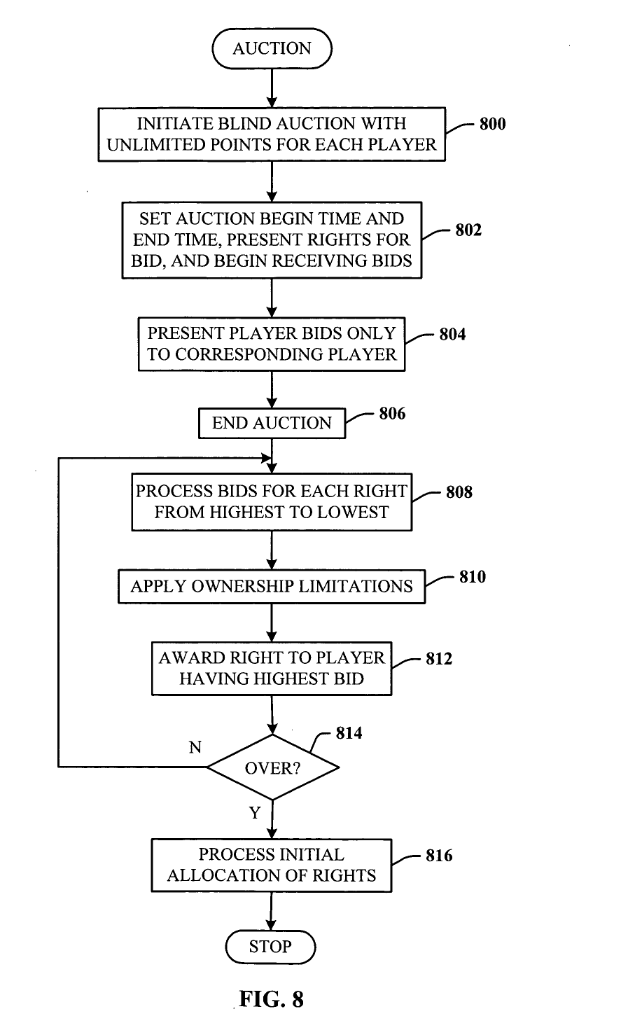

FIG. 8 illustrates a methodology of applying a blind auction mode with unlimited points configuration in accordance with the invention for purposes of initially allocating Rights. At 800, the blind auction is initiated with unlimited points for each player. At 802, the auction begin time and end time is set, and Rights for the Game are presented for each player to see. However, at 804, no other players' bids are presented to a given player. Each player sees only his or her bids. At 806, the auction phase ends. At 808, the bids are processed for each Right from the highest to the lowest. In auctions using unlimited points configuration, limitations can be applied such that a player is limited to a percentage of ownership of Rights with respect to a Dividend or a number of Rights during an RLE or otherwise in accordance with a Game Configuration. Accordingly, at 810, the system evaluates the validity of a bid given applicable limitations in accordance with the applicable Game Configuration. At 812, rights are awarded to the player with the highest bid. At 814, the system determines if the bid process is over. If not, flow is back to 808 to continue processing bids. Otherwise, at 814, flow is to 816 where the initial allocation of Rights is processed.

General Auction Features and Enhancements

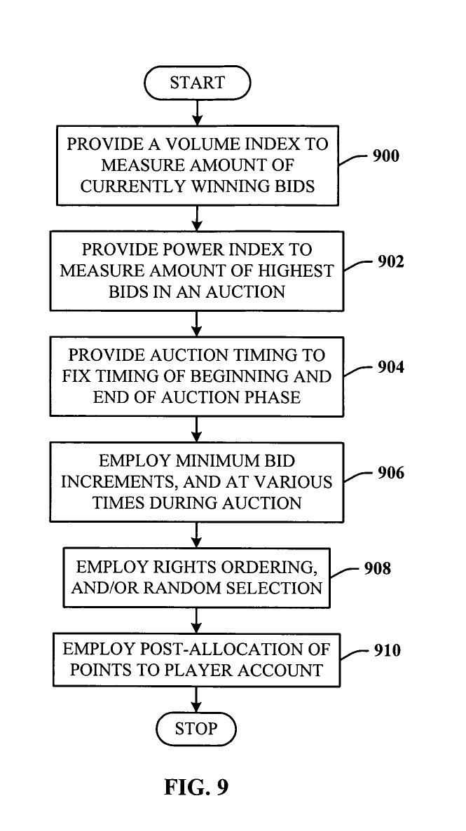

Certain other auction features and enhancements are within the contemplation of the subject invention. FIG. 9 illustrates a methodology of providing tools to assist player auction strategies and other features in accordance with the invention. The game system incorporates dynamic tools to assist players in determining their auction strategies. For example, at 900, a winning bid volume index tool is provided that measures the amount of currently winning bids in an auction. At 902, a power index tool is provided that measures the amount of the highest bids in an auction. These tools are especially helpful in any of the blind auction mode scenarios described herein. It is within the contemplation of the subject invention that other methods of providing enhanced auction strategy are available, for example, methods incorporating current real world data, Game Configuration information and Game statistics.

Another auction feature is that for any Right, the auction can be automatically extended by a certain amount of time any time a bid is submitted within a certain amount of time prior to the end of the scheduled auction end time for the Right, as indicated at 904. The amount of time in either case is configurable, e.g., a default selection of minutes can be used. This continues, with each bid extending the auction time for that Right until no bids have been submitted for that Right in the extension period, at which point the auction for that Right ends.

Yet another auction feature is that for any Right, the auction can be configured to permit minimum bid increments, as indicated at 906. Further, at different times in the auction, the amount of the minimum bid increments can vary in accordance with a Game Configuration. For example, a minimum bid increment for an auction for a Right might be 0.50 points, until the time that is thirty minutes prior to that scheduled end time for that Auction, after which the minimum bid increment can be two points.

Still another auction methodology, at 908, contemplates an auction in which the rights being auctioned are rights to select in a particular order from among the Rights being allocated. That is, players submit bids for certain positions within a draft order, with awards being made to the high bidder for each spot. Following the auction, a draft of the Rights is conducted with the players selecting in order of the highest draft position to the lowest the Rights that will be allocated to them initially. Alternatively, the draft order can be assigned randomly by the system.

Another feature that can be included in a Game Configuration is that after the initial allocation of any Rights, a certain number of points can be added to the balance of each player, in equal amounts or through some other methodology, as indicated at 910.

Another implementation of the auction procedures contemplated by the subject invention, involves accepting proxy-style bids with respect to any Right from players participating in an auction. If proxy-style bidding is permitted within a Game Configuration and enabled for a Game, a player is able to submit the maximum he or she is willing to bid for any Right and enter the amount as a proxy-style bid. As other players bid for the Right, the game system will confidentially and automatically submit bids up to the player's maximum amount. The player does not need to monitor the auction as it unfolds. If other players do not outbid the proxy-style bid maximum, the proxy-style bidder is allocated ownership of the Right at a winning bid price that is equal the next highest bid plus some fixed amount, possibly a minimum bid increment as described herein. If other players outbid the proxy-style bid maximum, the proxy-style bidder is not allocated ownership of the Right.

For example, if a first player placed a 25-point proxy-style bid for a Right with a current high bid of 3.50 and the preset proxy-style bid increment is 0.01 points, the game system sets the first player as the high bidder with a bid amount of 3.51. If another player bids 15, the system saves that bid, but will immediately set the first player as the high bidder with a bid amount of 15.01. The game system continues this process until another player enters a bid of more than 25, at which point the first player's bid becomes a losing bid, since others have gone higher. Other variations on adjusting the final bid are within contemplation of the subject invention, and which are suitable for competitive play in accordance with the game system.

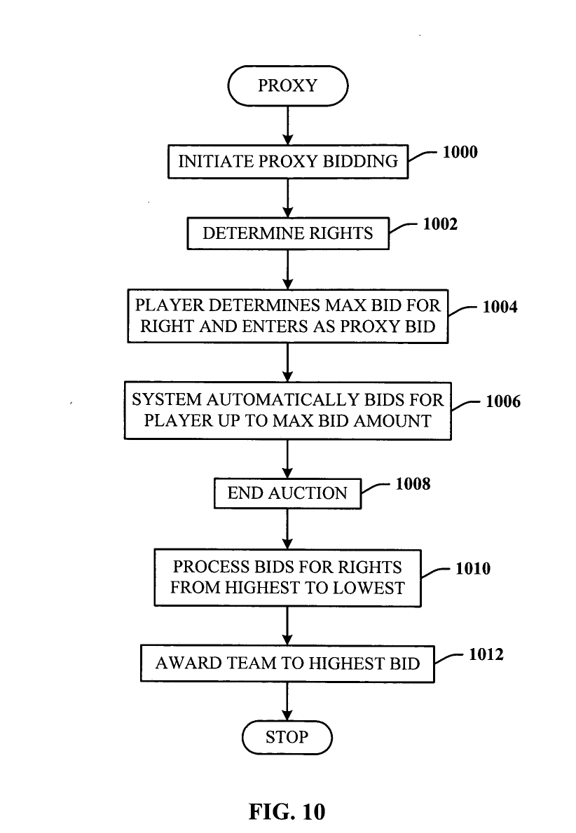

Referring now to FIG. 10, there is illustrated a methodology of applying proxy-style bidding in accordance with the invention. Accordingly, at 1000, proxy-style bidding is initiated. At 1002, Rights being allocated in the auction are determined. At 1004, a player decides the maximum he or she is willing to pay for a Right, and enters this amount as a proxy-style bid. As other players bid for the Right, the game system will confidentially and automatically bid up to the player's maximum amount, as indicated at 1006. At 1008, the auction time expires, and the auction ends. At 1010, bids are processed for each Right. At 1012, Rights are awarded to the players with the highest bids.

Another implementation of the subject invention contemplates that enhanced proxy-style bidding can be enabled for auctions where several Rights with respect to a Dividend are being auctioned. In operation, a player could submit a proxy-style bid specifying a percentage of the Rights with respect to a Dividend if the aggregate price for all such Rights was less than a certain amount. Such a bid could include a bid for any or all such Rights in such amount if the aggregate price for all such Rights was not in fact less than such amount.

Another implementation of the auction procedures contemplated by the subject invention, involves accepting bids through a Dutch auction system in an auction where a plurality of Rights with respect to one or more Dividends are being allocated separately. Under this implementation, players could bid the price that they would be willing to pay for one or more of such Rights and the system will allocate the Rights in accordance with the bids received. For example, if 100 Rights with respect to a Dividend were being auctioned in an auction a plurality of players could submit bids for some or all of such Rights. The system would process the bids and allocate the Rights so that each Right will be allocated for a price equal to the highest bid or at least in part in relation to some bid, for example at least in part in relation to the highest bid or at least in part in relation to the bid immediately below the highest bid for any given Right. Note that the Dutch auction implementation can also be implemented simultaneously with proxy-style bidding under certain circumstances.

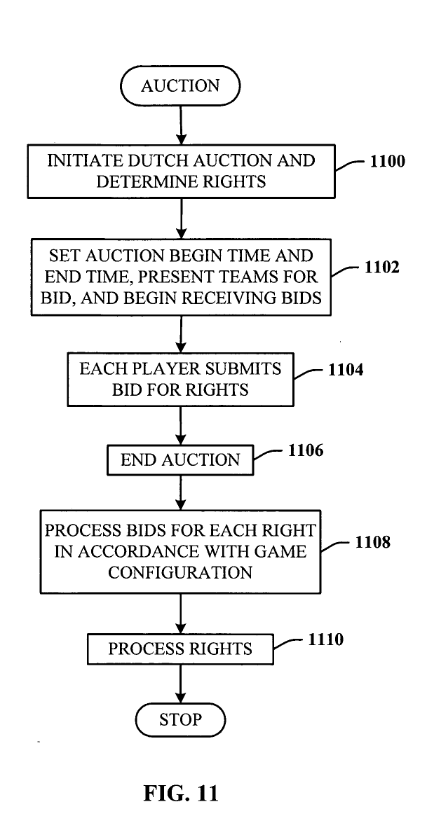

FIG. 11 illustrates a methodology of applying a Dutch auction in accordance with the invention. At 1100, the Dutch auction is initiated. At 1102, the auction begin time and end time is set, and Rights for the game are presented for each player to see. At 1104, each player submits one or more bids (which may be proxy-style bids) for Rights. At 1106, the auction ends. At 1108, the bids are processed for each Right in accordance with the Game configuration. At 1110, Rights are processed and allocated.

Another auction feature is that players submitting bids in a limited points auction can set a “reserve amount”, the purpose of which is for a player to strategically ensure that all allocated points are not spent in the auction. For auction processing purposes, the reserved points are deducted from the player's total.

Non-Auction Based Procedures for Initial Allocation of Rights

As described above, under implementations of the present invention, the initial allocation of Rights in any Game can be made pursuant to non-auction based procedures in accordance with a Game Configuration. Generally, non-auction based procedures include a mode and set of configuration options (e.g., limited points and unlimited points), and certain other elements. In one implementation of the subject invention, non-auction based procedures with respect to each of the Rights in a Game Configuration within a game occur simultaneously, with each Right available for allocation allocated through a single procedure. In one implementation of the subject invention, non-auction based processing occurs through the facility of an interactive computer-network based user interface.

The subject invention contemplates that, in one implementation, the non-auction based procedure to be used for a Game can be given for a particular Game Configuration; in another implementation, players and/or Commissioners can be permitted to select the procedure to apply to a particular Game from among all or some of the different versions permitted by the Game Configuration. The procedure and configuration options chosen have a significant impact on the Game experience and strategy. The best procedure and configuration options for any Game depend upon the preferences of the players in that Game.

Under one implementation of the subject invention, a non-auction based procedure can allocate Rights among players in a Game through a random or semi-random allocation processes, including both processes where receiving a Right allocation modifies a player's chances of receiving additional Right allocations and processes where receiving a Right allocation does not alter a player's chances of receiving additional Right allocations. Under another implementation of the subject invention, non-auction based procedures can permit players to submit criteria or preferences that would be weighted and incorporated into a semi-random allocation process. Under another implementation of the subject invention, non-auction based procedures can access real-world information sources for data and incorporate the data into a semi-random allocation process. Configuration options and other features with respect to auction based procedures as described herein, to the extent not inconsistent with a particular non-auction based procedure, are available in the context of non-auction based procedures as well. These are only but a few examples of non-auction based procedures, as many other such procedures are within the scope of the subject invention, but not listed here for sake of brevity.

Market and Market Phase

Upon completion of the initial allocation of any Rights, the market phase of the Game with respect to those Rights commences during which Dividends are awarded to those players owning the Rights to receive them upon the occurrence of the related Dividend Events. During the market phase, players can buy and sell Rights (for points) and can trade Rights for other Rights through an interactive process. Since the objective of the game is to accumulate as many points as possible, players use their own opinions of the value of any given Right (which is in part a function of the likelihood that the Dividend Events to which the Right relates will occur) to determine how many points or what other Rights (valued accordingly) they are willing to exchange for any Right.

For example, in the case a Right to receive a dividend upon a team's winning a championship, the value of that Right would be in part a function of team's chances of success. Specific features of the present invention relating to the market phase of the game format are described herein. In one implementation of the present invention, during the market phase players in a game can submit and accept bids, ask and trade offers substantially simultaneously through an intuitive online interface and can view the current standings in the game remotely as the Event progresses through online presentation. In another implementation of the present invention, Game information is managed and presented and initial allocations of Rights, exchanges of Rights and Dividend awards are processed through an online user interface linked to automated database processing.

During the market phase, players can use points to buy Rights from other players or from the system, in the case of a Right not allocated during an initial allocation process. Players can also sell Rights to other players for points. Players can also enter into direct Rights-for-Rights trades or trades involving exchanges of Rights and points. Every purchase, sale, and trade can be subject to review by the Commissioner of the Game for fairness, or subject to a vote of the players. Just as the initial allocation of Rights procedures are unique to the game format; the market phase is a unique part of the ongoing gaming experience.

During the market phase, Dividends are awarded upon the occurrence of a Dividend Event with respect to a Right to the holder of the Right at the time the Dividend Event occurs in accordance with the applicable Game Configuration.

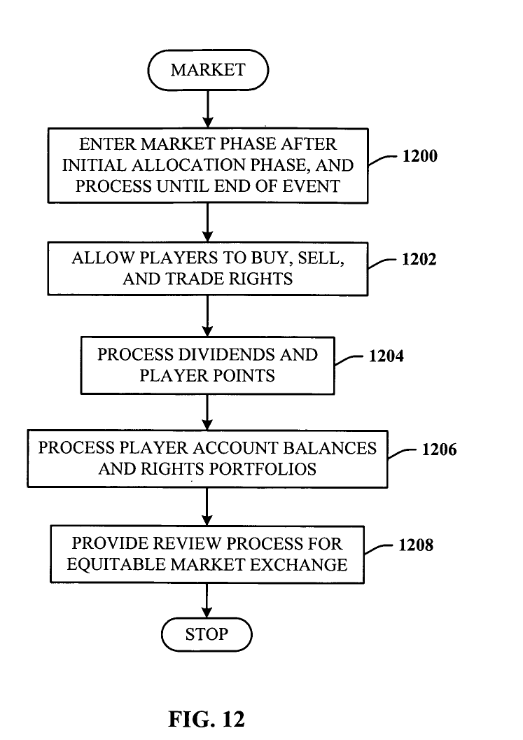

Accordingly, FIG. 12 illustrates a methodology of implementing market-based transactions in accordance with the invention. At 1200, the market phase with respect to any Right is entered after the initial allocation with respect to such Right. The market phase can continue throughout the RLE. At 1202, players are allowed to perform transactions such as buying, selling, and exchanging Rights. At 1204, Dividends and player points are processed according to transactions performed during the market phase and the Game Configuration. At 1206, player account balances and Rights portfolios are processed to add and subtract points and transfer Rights according to the transaction. At 1208, the review process is provided.

In one implementation of the subject invention, during the market phase, one or more Rights aggregated with other Rights at the time of initial allocation can be disaggregated subsequent to the initial allocation and transferred or exchanged independently of the Rights with which originally aggregated. The subject invention contemplates that optionality with respect to the ability to disaggregate Rights from other Rights as described herein can be implemented within a Game Configuration and can allow Game level activation or deactivation by a Commissioner.

In one implementation of the subject invention, Rights' allocations to players are made available to the other players in a Game. That is, each player is able to know which Rights are held by the other players. In another implementation, such information with respect to a player is not available to one or more of the other players and the market phase procedures are conducted without such information being made available.

It is to be appreciated that other types of market-based transactions can be employed in accordance with the subject invention. For example, a market short sale type of transaction can be utilized such that a player can choose to sell a Right that the player does not currently own and incur an obligation to deliver the Right to the purchaser not later than at some point in the future.

In yet another variation, a Game Configuration can allow a player to borrow points from other players or from a point bank and incur an obligation to repay the borrowed points in accordance with system- or user-defined terms. For example, an obligation to repay borrowed points can include an obligation to include additional points as part of the repayment (similar to interest on traditional debt) and can include a time limit such that the player must have satisfied all or a portion of the repayment obligation by not later than a specified time or specified times during the progression of the RLE.

Other Features

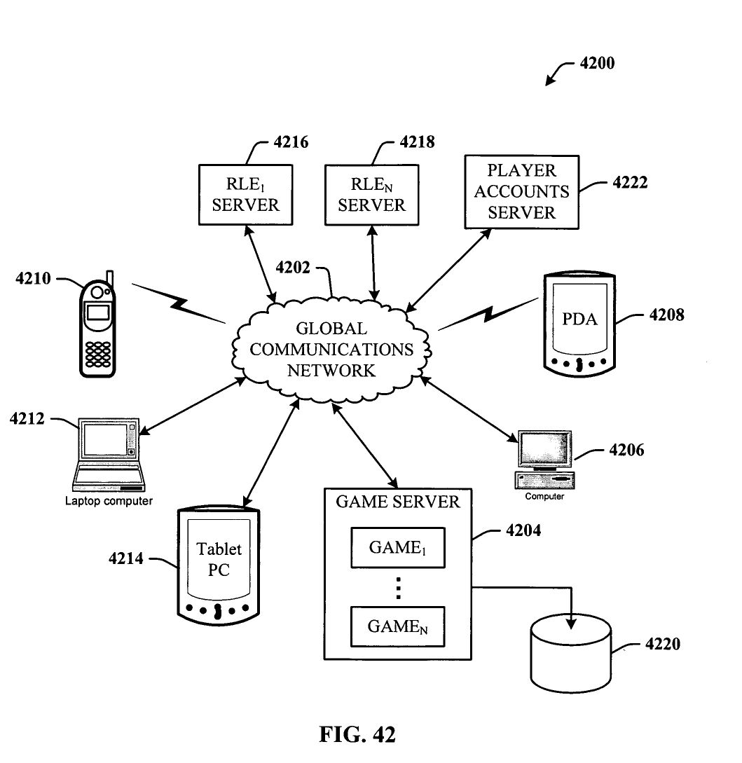

In another implementation, the system facilitates financial transactions such that a Game is not only played with points, but the points, final standings, and intermediate objectives are rewarded in terms of money. Thus, when a user plays one or more Games, personal account information can be input such that the player's performance has a financial impact on a player account. In support thereof, the system contemplates display and processing capability, which facilitates accessing the player financial accounts and crediting or debiting such accounts accordingly, in relation to the player's performance in Games. In support thereof, a system 4200 of FIG. 42 can include banking and/or credit card servers, denoted collectively as a player accounts server 4222, which facilitates accessing the player financial accounts and crediting or debiting such accounts accordingly, in relation to the player's performance in Games.

The subject invention contemplates, for example, that players in a Game with Rights being initially allocated in an open auction mode with limited points configuration under a Game Configuration where each player is initially allocated 100 points at the commencement of such Auction can choose to have each point in the Game represent a single dollar or other unit of currency (to be deposited into a Game fund by each player in the case of points initially allocated) and for the results of the Game to determine the disposition of amounts deposited in the Game fund. Thus, in the present example, the $100 deposited by each player in the Game fund might be divided among the players with the three highest point totals at the end of the game. The subject invention contemplates other monetary reward systems as will be appreciated by one skilled in the art.

It is also within the contemplation of the subject invention that methods of providing enhanced strategic decision making to players can be made available during the market phase of any Game. For example, various methods incorporating real world data, Game Configuration information and Game statistics and are made available to assist players in determining appropriate values for any given Right or set of Rights in the Game.

Game Management

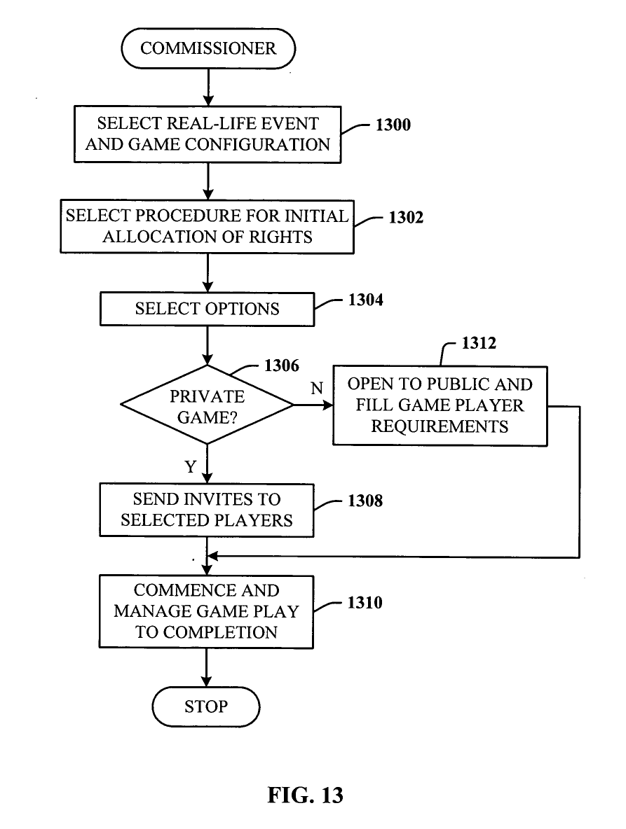

FIG. 13 illustrates a methodology of managing a Game in accordance with the invention. Generally, private Games for any RLE can be established by the Commissioner, which is an administrator who can also be a player in the game. The Commissioner selects the Game Configuration and, as available within the Game Configuration, the procedures to be used for purposes of determining initial allocations of Rights and other configuration options for the Game. The other players in a private Game are invited (e.g., by automatic e-mail invitation, which is optional) by the Commissioner to join the Game, and are given a password and other Game identification information. Participation in a private game is solely upon invitation of the applicable Commissioner. Public games can also be configured and provided for users to join.

Accordingly, at 1300, the Commissioner determines the RLE and the Game Configuration for the Game. At 1302, the procedures to be used for purposes of determining initial allocations of Rights are selected. At 1304, other options are selected, including whether a Game is public or private. If private, flow is from 1306 to 1308 to send invites to selected players. Although e-mail is one method of notification, other conventional means are within contemplation of the subject invention, including but not limited to physical communication, telephone, VoIP (Voice over IP), text messaging to a wireless text messaging device, posting to a website that is restricted to selected users, and cellular telephone (voice and/or messaging). At 1310, the Commissioner commences Game play and manages play to completion. At 1306, if the Game is not private, it is public, and flow is to 1312 to open the game to the public to fill Game player requirements. This can also require registration of the public player before access to the Game. The process then continues to 1310 to begin and manage the game.

Sample Game

The following is a description, generally in chronological order, of a simplified Game using a format within the contemplation of the subject invention. Other variations on the format as described herein are within the contemplation of the subject invention.

In the simplified Game described herein the initial allocation of rights is being processed using an open auction mode configured with limited points in the context of a fictional Major League Baseball (MLB) scenario. The applicable Game Configuration (as would be determined in accordance with the subject invention as described herein) specifies that for a Game based on the Event of MLB involving the number of players involved in the Game, each player would begin the Game with 100 points.

Assume that the applicable Game Configuration also specifies that certain Rights with respect to Dividends are bundled together for purposes of both the initial allocation of such Rights and market phase transactions and Dividend awards such that all Rights with respect to all Dividends and all Dividend Events with respect to any particular team in the Event are held together by a single holder. That is, all Rights with respect to any given team and the Dividends that are awarded with respect to Dividend Events occurring with respect to such team are held together. For example, a single player would own all Rights to all Dividends awarded upon the occurrence of Dividend Events with respect to a particular team. Also assume that the applicable Game Configuration specifies that all to be allocated within the Game are to be allocated in a single allocation process at the beginning of the Game.

Also assume that the applicable Game Configuration specifies that Dividend Events with respect to each team in the Event and Dividends for the Game will be as follows:

| Dividend Events | Dividend |
|---|---|
| Each time a team wins a game | 1 |
| Each time a team wins a game by more than 4 runs | 2 |
| Each time a team shuts out an opponent | 3 |
| Each team that advances to the semifinals | 50 |
| Each team that advances to the finals | 100 |
| Team that wins the championship | 150 |

Note that bundling of Rights related to Dividend Events with respect to each team permits Dividend Event and Dividend definition within a Game Configuration to be team-based and is within the contemplation of the subject invention, but is not a requirement of the subject invention.

Within this Game Configuration and the simplified Game, a player named Jackson decides to form a game for the upcoming MLB season (which is the RLE that is the subject of Jackson's game). Jackson invites five friends to participate in the game—Tim, Bill, Jeff, Roger, and Andrew. At the beginning of the Game, each player (Jackson, Tim, Bill, Jeff, Roger, and Andrew) is allocated 100 points for the Game in accordance with the Game Configuration and other components of the Game Configuration are made available to the players, including information relating to Dividends and Dividend Events and Rights within the Game. In this simplified example, it is assumed there are ten teams in two leagues, as follows: American League-Yankees, Red Sox, Orioles, As, Rangers, and National League-Dodgers, Marlins, Diamondbacks, Giants, Mets; and that Rights related to Dividend Events with respect to each such team are bundled as described above.

Based on the Game Configuration, including the available Rights, Dividend Events and Dividend amounts, the players develop their auction strategies. Each player can submit a bid for each set of Rights. In the implementation described in this simplified example, since all Rights related to Dividend Events with respect to each such team are bundled together, another way to conceptualize the players' bidding is to think of each bid submitted as a bid for ownership of all Rights with respect to a team, or, more simply, as a bid for ownership of the team. The aggregate of a player's currently winning bids cannot exceed the 100 points allocated to the player at the beginning of the Game. There are dozens of bids submitted as the players implement their auction strategies and bid, get outbid, and re-bid. A short example of what might occur is the following:

Roger starts bidding and bids 10 on every team (or more specifically, on the Rights with respect to those teams being allocated), using up his entire initial allocation of points. As the other players consider Roger's bids, they can outbid him. Tim decides that he wanted to bid 20 on each of the Yankees, Red Sox, Orioles, Dodgers and Marlins (or more specifically, on the Rights with respect to those teams being allocated). That uses up Tim's entire initial point allocation (assuming the only other bids at the time are Roger's bids) and frees up 50 points of Roger's initial allocation.

When Jackson comes in and bids 30 for the Yankees (or more specifically, on the Rights with respect to such team being allocated), 20 points of Tim's initial allocation are freed up. If Tim attempts to bid 31 on the Yankees to beat out Jackson's bid, he will not be able to do so because, with four 20-point bids still outstanding, he will have only 20 points (100 points of his initial allocation minus the four 20-point bids he has outstanding) with which to bid. As other players place bids, Roger, Tim and Jackson will need to modify their bids in order to keep pace with the amounts the other players are bidding. At the end of the Auction, the high bids on the teams (or more specifically, on the Rights with respect to the teams being allocated) are as follows:

| Team | Bid | Owner |
|---|---|---|
| Yankees | 80 | Roger |
| Red Sox | 65 | Jackson |
| Orioles | 60 | Andrew |
| Dodgers | 57 | Bill |
| Marlins | 55 | Jeff |
| Diamondbacks | 50 | Tim |
| As | 44 | Jeff |
| Rangers | 43 | Bill |
| Giants | 26 | Andrew |
| Mets | 25 | Jackson |

In accordance with applicable auction processing rules as described herein, the initial allocation of each team (or more specifically, of the Rights with respect to each team that are being allocated) is made to the high bidder and each player's point balance is reduced by the amount of the player's winning bids.

Based on the results of the Auction and the winning bids, the initial allocation of Rights results and the players' point balance at the commencement of the market phase are as follows.

| Player | Remaining Points | Rights (Teams) |
|---|---|---|
| Roger | 20 | Yankees |
| Jackson | 10 | Red Sox, Mets |
| Andrew | 14 | Orioles, Giants |
| Bill | 0 | Dodgers, Rangers |
| Jeff | 1 | Marlins, As |
| Tim | 50 | Diamondbacks |

Upon completion of the Auction, the market phase opens and Dividend awards are made as the teams compete in and Dividend Events occur during the RLE. The Yankees win their first 5 games, including a 5-0 victory over the Red Sox. Because Rights with respect to Dividend Events relating to the Yankees are allocated to Roger, he receives 6 points of Dividends for the victory over the Red Sox (based on the occurrence of three separate Dividend Events occurring during the game—a win by the Yankees (1 point), a win by the Yankees by more than 4 runs (2 points) and a shutout by the Yankees (3 points)) and a 1 point Dividend for each of the other Yankee victories during those games, bringing his total to 30 points.

As the other players strategize ways to keep up with Roger, they consider opportunities to buy, sell or trade teams (or more specifically, the Rights with respect to teams) on favorable terms. The Mets win several games, earning Dividends for Jackson, but he thinks they are not a good team and that they will start to falter soon. Fortunately for Jackson, Tim has a balance of 50 points and makes an offer to purchase the Mets (or more specifically, the Rights with respect to the Mets) for 45 points. Jackson happily accepts. The points are deducted from Tim's balance and added to Jackson's and ownership of the Mets (or more specifically, the Rights with respect to the Mets) is re-allocated to Tim.

As the RLE progresses, the players accumulate points based on the teams' successes and failures and the Dividends awarded in light thereof, and the exchanges they make with other players, all with an eye toward the larger Dividends awarded as a result of the Dividend Events related to teams making the playoffs. As the regular season for the RLE ends, the standings for the Game are as follows:

| Player | Points | Rights (Teams) |
|---|---|---|
| Roger | 250 | |
| Jackson | 220 | Orioles, Dodgers |
| Andrew | 217 | As, Diamondbacks |
| Bill | 205 | Rangers, Giants |
| Jeff | 145 | Marlins |
| Tim | 100 | Yankees, Mets, Red Sox |

The Team standings at the end of the regular season of the RLE are as follows:

| American League | National League |
|---|---|
| 1. Yankees | 1. Dodgers |
| 2. Red Sox | 2. Giants |
| 3. As | 3. Marlins |
| 4. Orioles | 4. Diamondbacks |
| 5. Rangers | 5. Mets |

Roger has accumulated the most points so far, but he owns no teams (or more specifically, he owns no Rights with respect to any teams), so unless he acquires additional Rights, he will not receive any additional Dividends. Tim has the accumulated the least points, but he owns 3 teams (or more specifically, he owns the Rights with respect to 3 teams). The trades that occur and the teams' performance will determine who wins the Game. Desperate for a team (or more specifically, for Rights with respect to a team), Roger offers 96 points for the Giants and Bill accepts, bringing Bill's point total up to 301 and Roger's point total down to 154.

Since the top two teams in each league make the playoffs and thus advance to the semifinals, which is a Dividend Event for the Game, the owners of the Yankees, Red Sox, Dodgers and Marlins (or more specifically, the owners of the Rights with respect to the Yankees, Red Sox, Dodgers and Marlins) will each receive Dividends of 50 points. Tim's point total is now 200, Roger's point total is 204 and Jackson's point total is 270. Assuming no further exchanges occur, when the Yankees beat the Red Sox and the Giants beat the Dodgers, 100 point Dividends are awarded to Roger and Tim as they own the teams (or more specifically, the Rights with respect to the teams) that advance to the finals, which is a Dividend Event for the Game. The standings at that point are as follows:

| Player | Points | Rights (Teams) |
|---|---|---|
| Roger | 304 | Giants |
| Bill | 301 | |
| Tim | 300 | Yankees |
| Jackson | 270 | |
| Andrew | 217 | |
| Jeff | 145 | |

Assuming no further trading, the winner of the Giants and Yankees will determine the winner of the Game and the runner up as well. The last Dividend Event that will occur for the RLE is a team's winning of the championship. A 150-point Dividend will be awarded to the player owning the team (or more specifically, the Rights with respect to the team) that wins the championship. When the Yankees win the championship, Tim is awarded the Dividend to bring his point total to 450. The RLE is over and Tim's point total is highest.

Game System with Artificail Intelligence

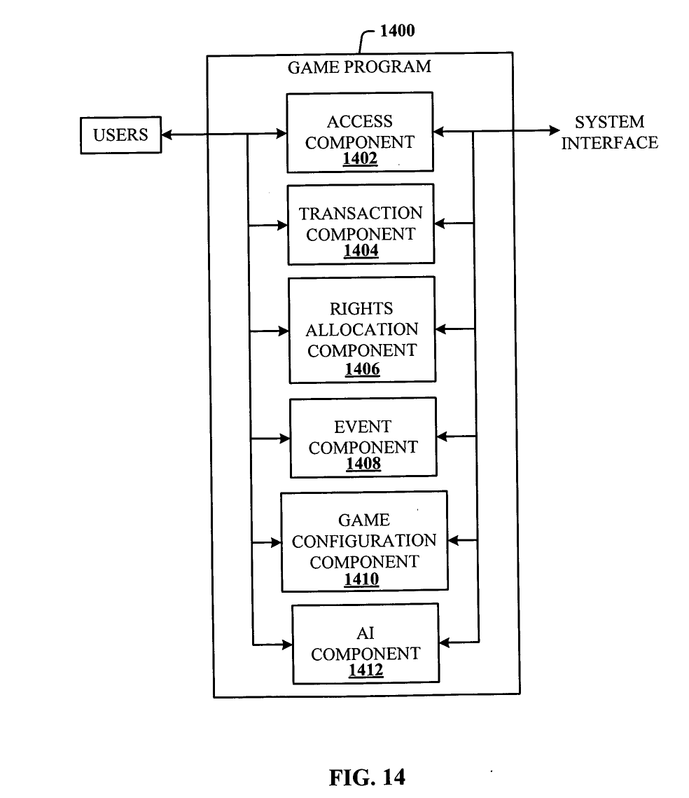

FIG. 14 illustrates a software game system 1400 that employs artificial intelligence (AI) in accordance with the invention. The system 1400 includes components (1402, 1404, 1406, 1408 and 1410) that are similar to the respective components (102, 104, 106, 108 and 110) of FIG. 1. Additionally, an AI component 1412 is provided that facilitates learning and automating one or more features associated with the game system 1400. The subject invention can employ various AI-based schemes for carrying out various aspects thereof. For example, a process for determining which information can be presented and how it will be presented to a given player can be facilitated via an automatic classifier system and process.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed.

A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naive Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject invention can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to receiving and processing data of a private player who routinely plays games in the format, and determine what information to present to the player during a Game. For example, if the RLE is a football game, which the player could be watching via streaming video over a computer, a portion of a webpage can be allocated to presenting updated information related to other Rights that player owns for that Game, or any other Games in which he or she may be participating. Additionally, upon registration to play a Game, certain user preference information can be obtained that further allows targeting the player with information related to the preferences.

Numerous other capabilities and features can be provided when utilizing AI in accordance with the subject invention, and are within contemplation of the subject invention. For example, if the player logs in remotely to check on the status or standings, the desired information can be customized according to the method of communications. If a cell phone, the information can be communicated as text only. If the device is a PDA, the information can be communicated more robustly to include graphics, and perhaps music, audio, etc. Upon registration, such devices of the player can be registered such that when the method of communications is ascertained, the desired information can be communicated accordingly.

General User Interface

As described herein, it is within the contemplation of the subject invention that under one implementation of the subject invention that Games played under the gaming format described herein and/or certain information with respect thereto be made available or accessible or otherwise be distributed through an online network of computers or other remote access devices. The following paragraphs describe generally, with appropriate references to drawings included in this application where applicable, an implementation of the invention through an online user interface provided through a website. It is understood that the following paragraphs include examples of one aspect of the invention. It is, of course, not possible to describe every conceivable combination of webpages or methodologies or user interface for purposes of describing the subject invention, but one of ordinary skill in the art may recognize that many further combinations and permutations of the invention are possible. Accordingly, the invention is intended to embrace all such alterations, modifications and variations that fall within the spirit and scope of the appended claims. With respect to any and all of the webpages described herein, the look, graphics, design, and options can vary significantly according to conventional design techniques and interactive options.

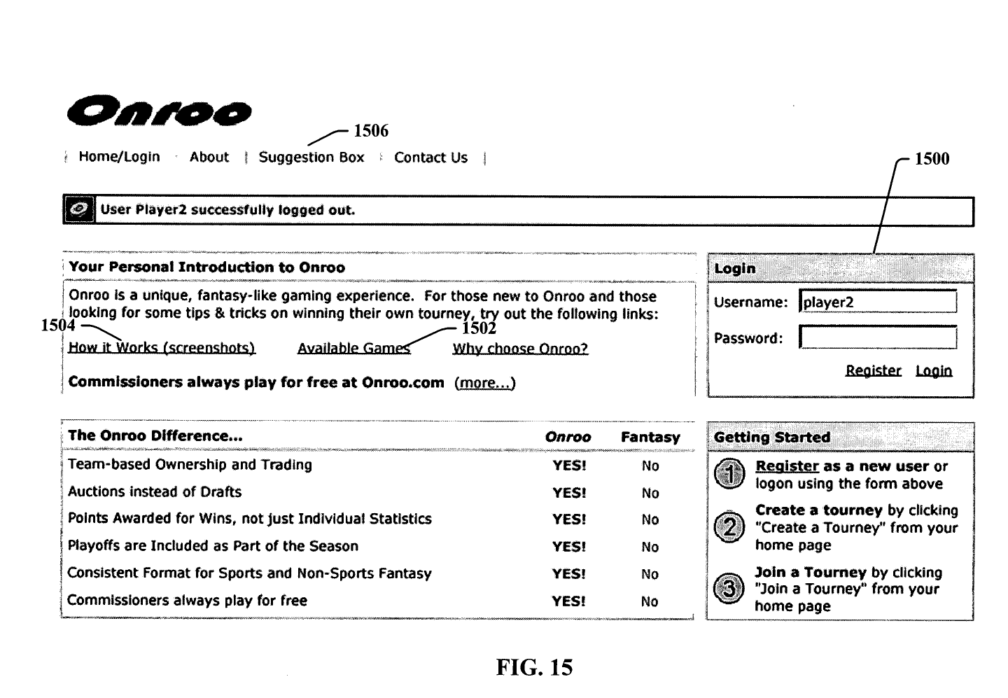

FIG. 15 illustrates a screenshot of the website general home webpage of the invention. The general home webpage includes a login screen 1500 that prompts a user for a usemame and password. Such login information can be obtained via a registration process and can be required in order to permit participation in Games via the website. The general home webpage also includes links to allow the user to navigate to corresponding information, functions and services, e.g., links to the user-specific home webpage, more information about Games available on the website 1502 (“Available Games”) and how the game format and website function 1504 (“How it Works”), a suggestion box 1506 (“Suggestion Box”), and other information made available on the website.

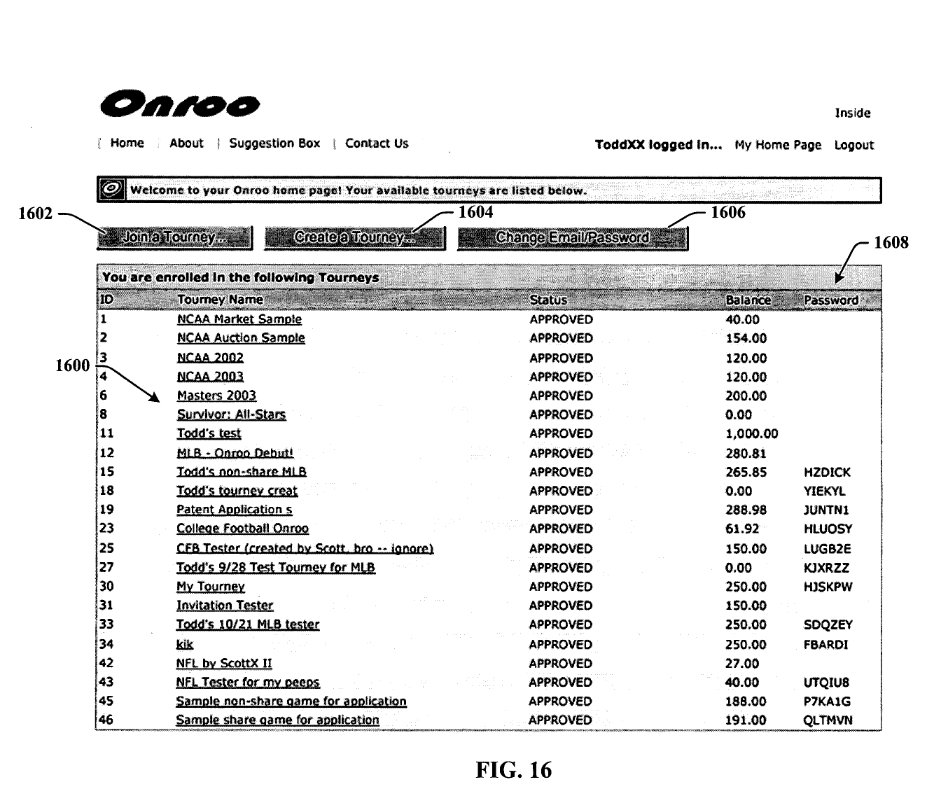

FIG. 16 illustrates a screenshot of a particular user's home webpage. Each user's home webpage includes a listing of hyperlinks 1600 and related information with respect to each Game that the user participates in through the website and also includes links to navigate to pages where actions like joining a Game 1602, creating a Game 1604, or modifying the user's website specific information 1606 are permitted. The links to the Games in which the user is participating allow the user to navigate directly into a portion of the website where Game-specific information and actions by players in the Game are permitted, and which is generally accessible only by the players in the Game. A Password column 1608 is also presented that lists the Game password required for accessing a particular Game.

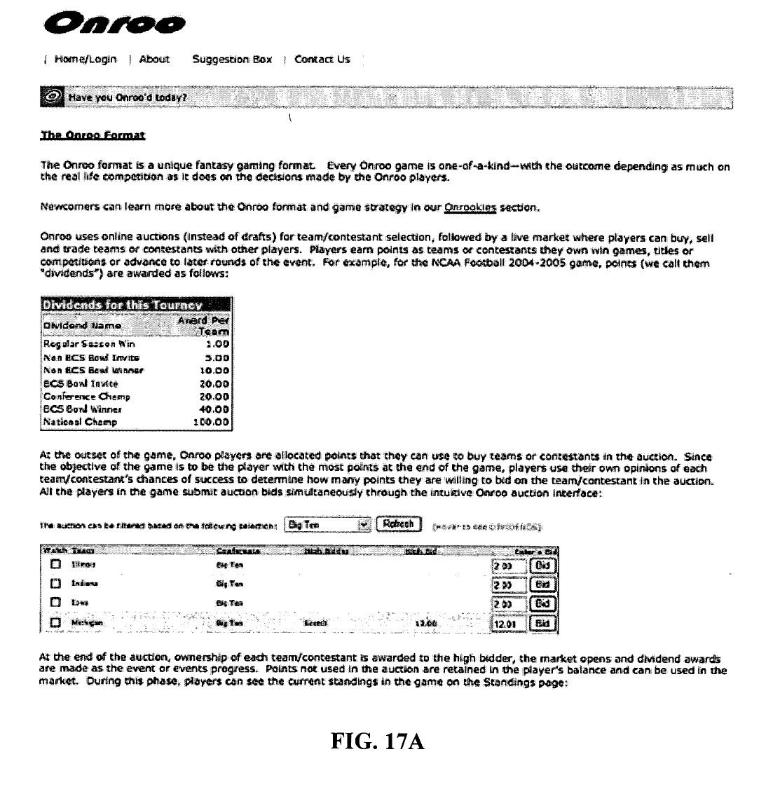

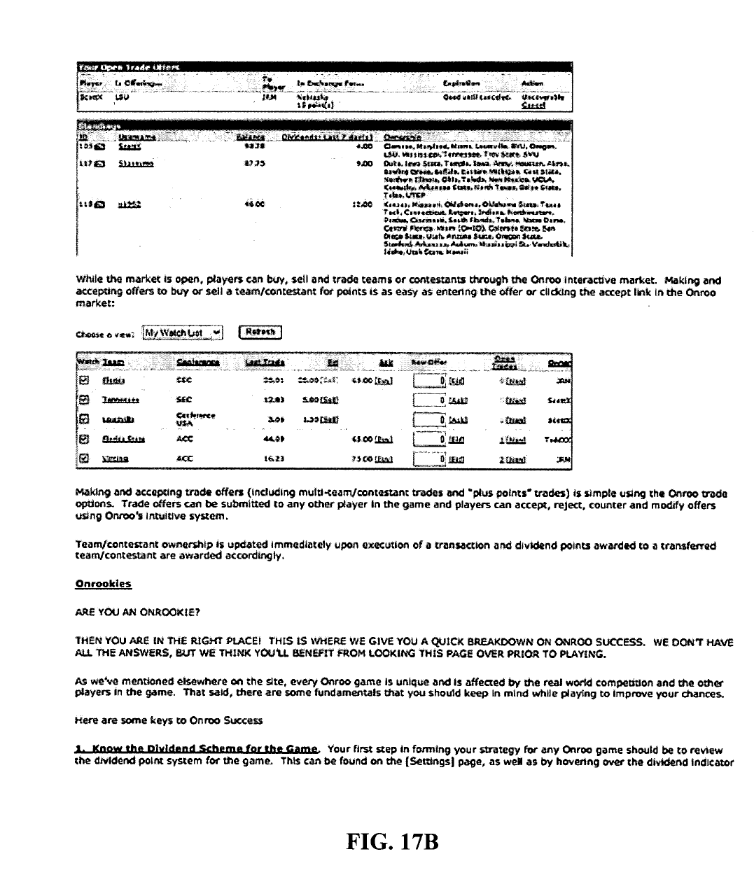

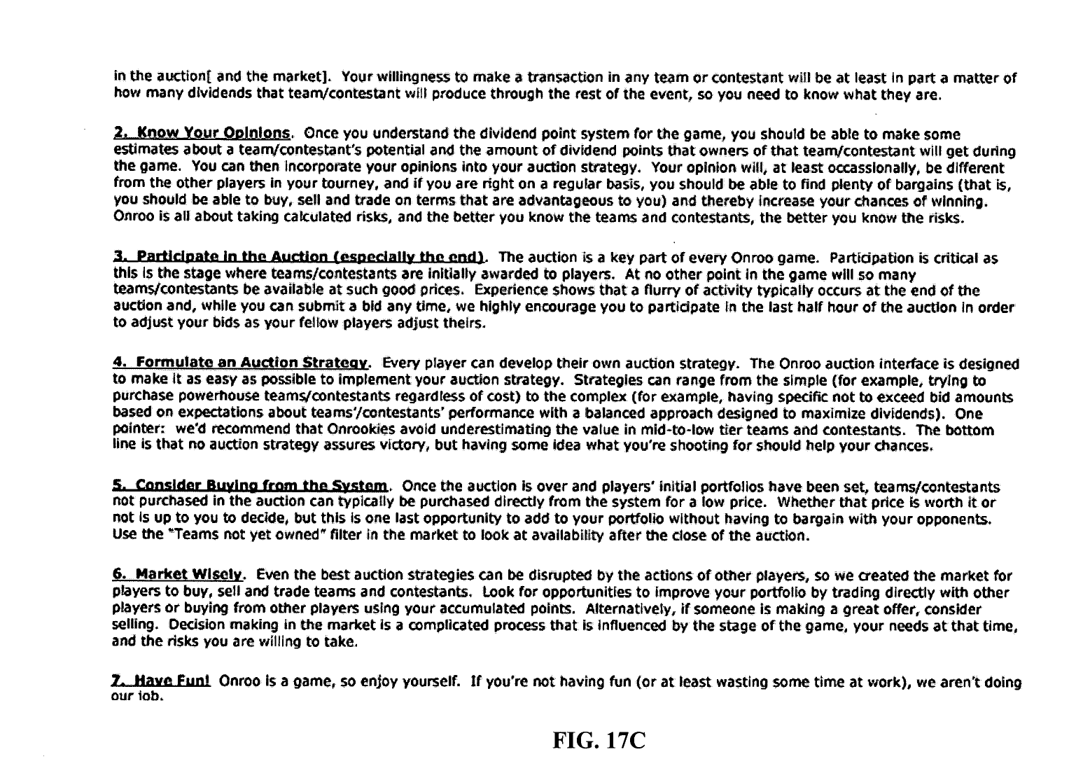

FIGS. 17A, 17B, and 17C illustrate screenshots of an informational webpage providing users of the website information regarding website procedures and functions, the game format and strategy.

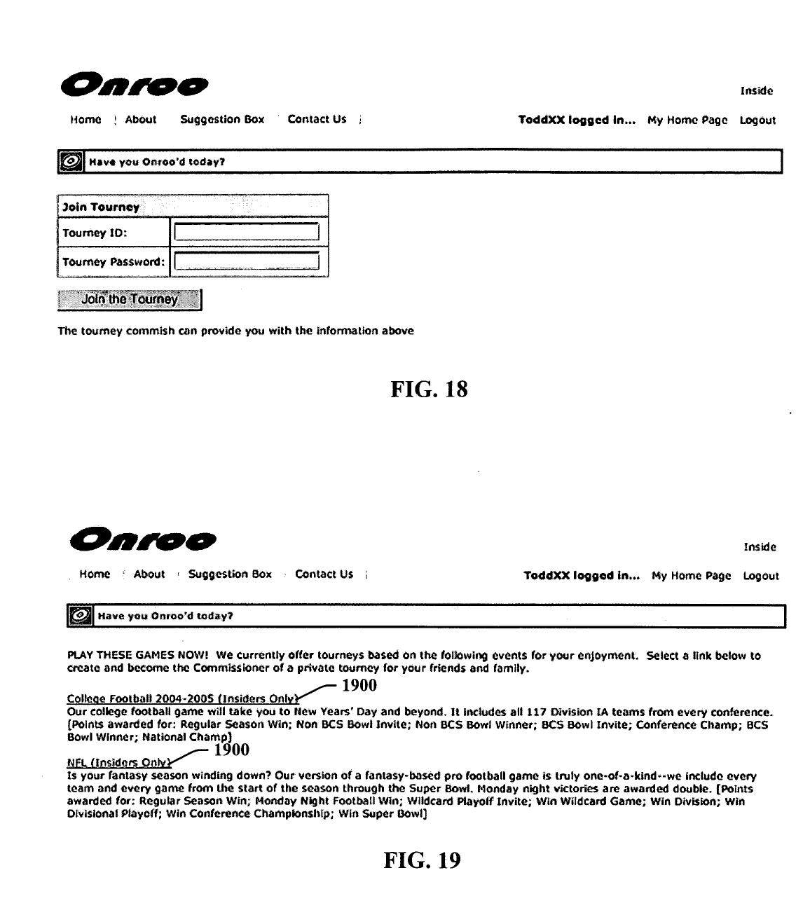

FIG. 18 illustrates a screenshot of a webpage that allows a user to join a Game by entering information provided by the Game Commissioner.

FIG. 19 illustrates a screenshot of a webpage that allows a user to select from among available Game Configurations 1900 the configuration that the user would like to use to create a Game to be played on the website.

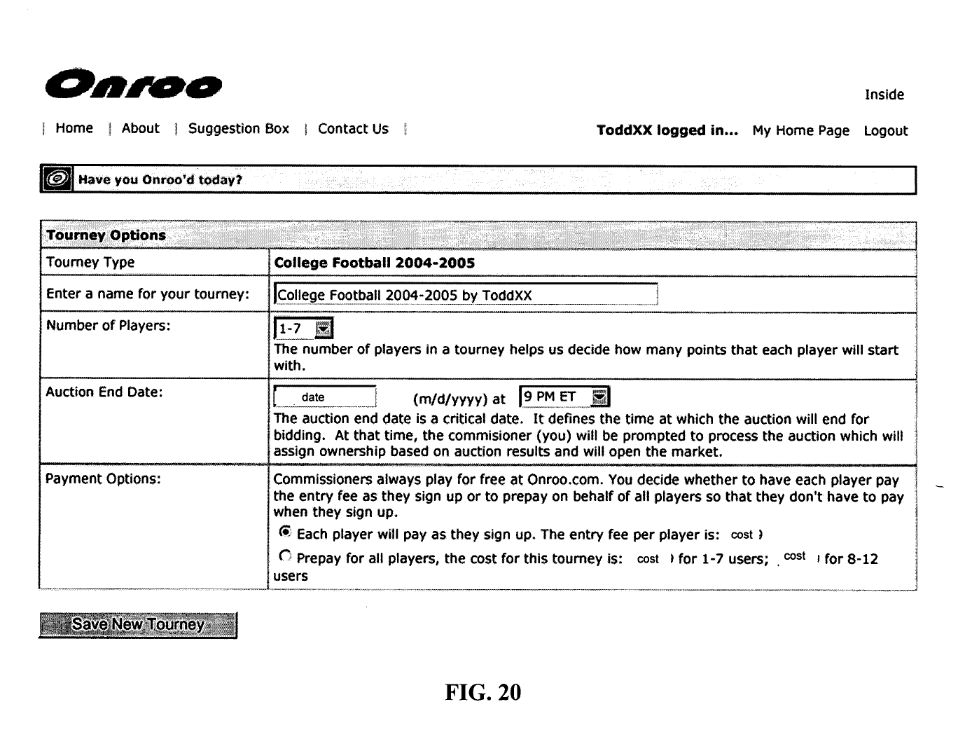

FIG. 20 illustrates a screenshot of a webpage that permits a user to create a Game to be played on the website within the Game Configuration selected by the user from among choices as illustrated in FIG. 19 and to submit certain Game specific information with respect to the Game.

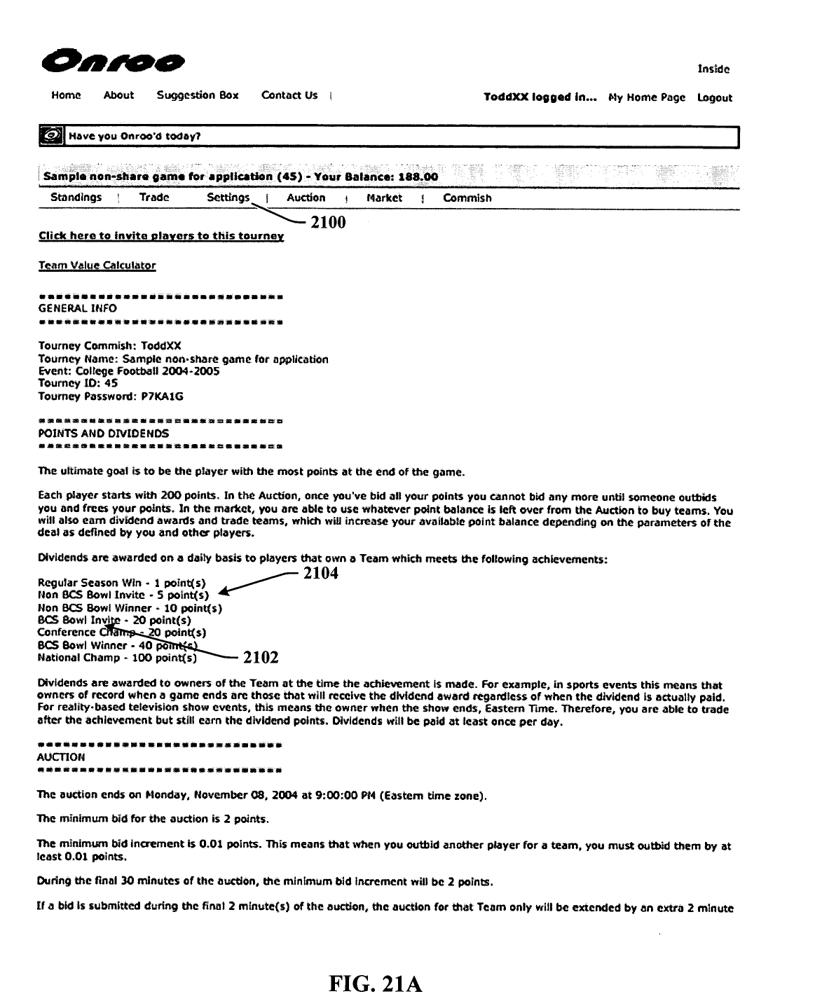

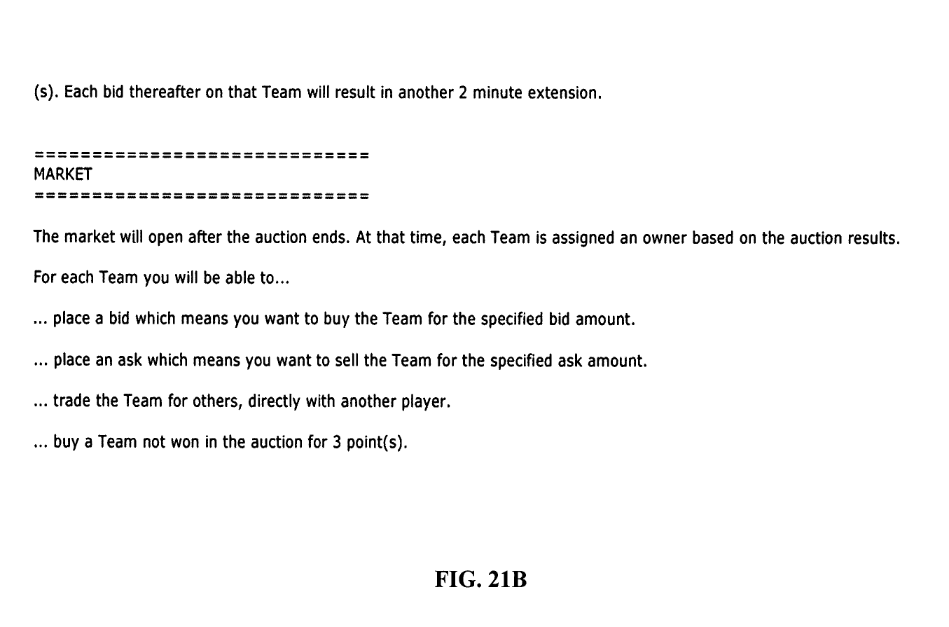

Information with respect to each Game played through the website is provided through a limited access portion of the website made available only to participants in the Game. FIG. 21 through FIG. 28 illustrate screenshots of webpages within the Game-specific portion of the Site for a Game within the format of the subject invention in which all Rights related to each Dividend Event with respect to a team's performance in the related Event are bundled and allocated to a single owner as described herein.

FIG. 21A and FIG. 21B illustrate portions of a screenshot of a webpage that provides detailed information with respect to the particular Game. This information is accessible through links made available on various other webpages within the Game-specific portion of the website (e.g., under the “Settings” links 2100) and includes combined information relating to the Game Configuration and options selected by the Commissioner. The webpage includes the tournament status bar, a list of applicable Dividend Events 2102 and Dividend amounts 2104. Various other Game properties are presented as well.

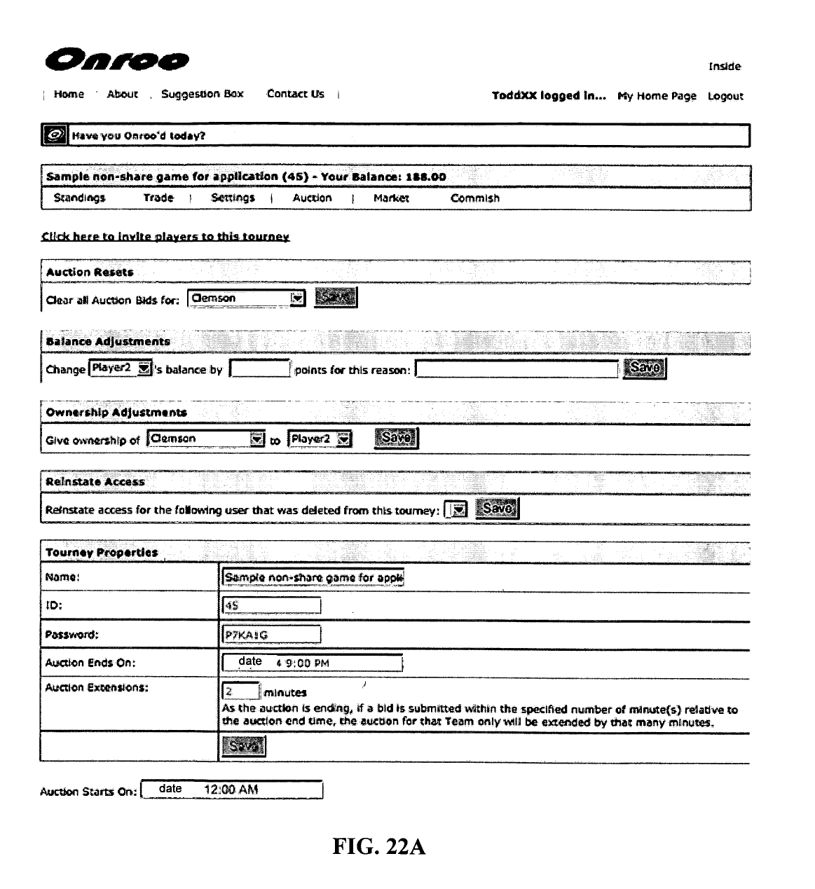

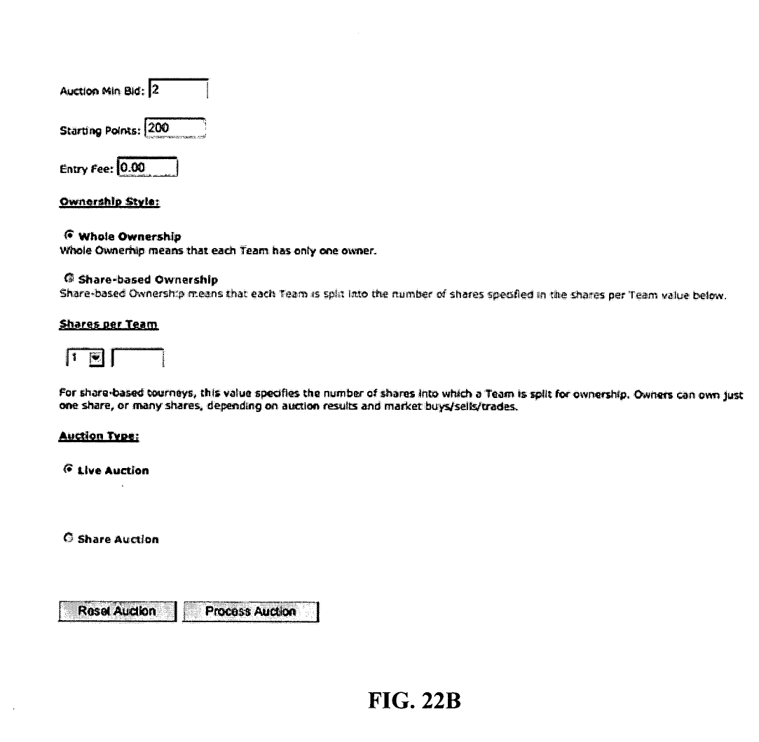

FIG. 22A and FIG. 22B illustrate portions of a screenshot of a webpage through which a user who is the Commissioner of the Game can view and modify certain Game Configuration options and other information relating to the Game.

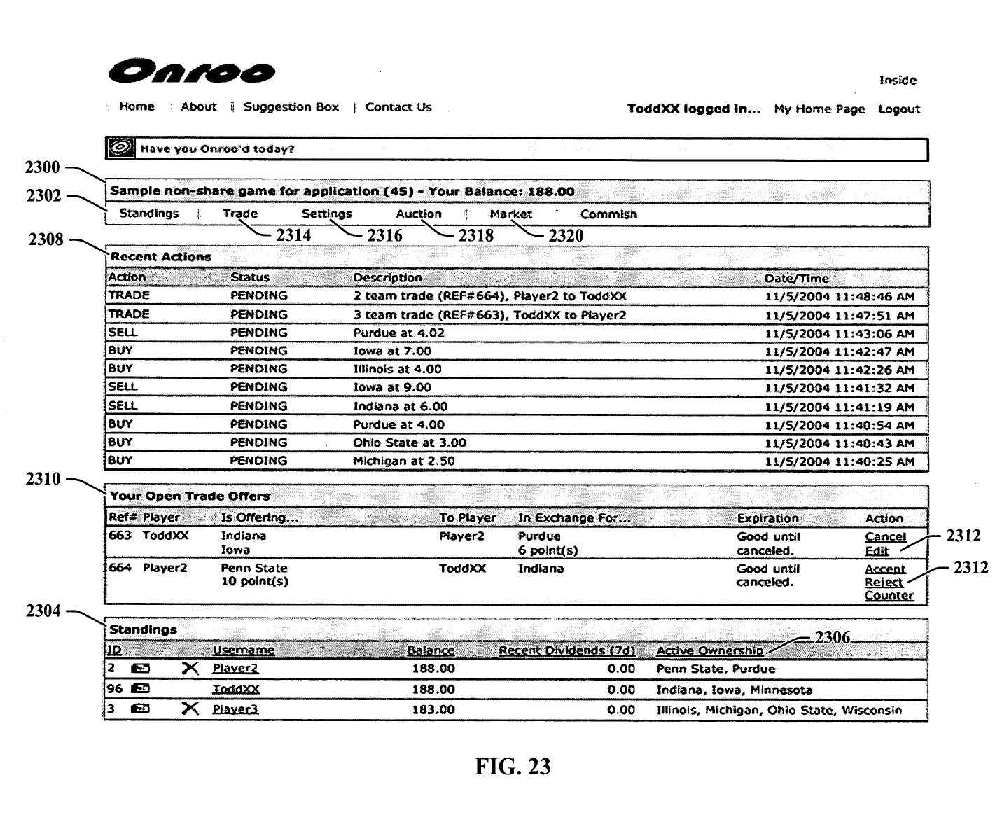

FIG. 23 illustrates a screenshot of a Game-specific home webpage of the Game. The Game-specific home webpage for a Game, in addition to identifying the subject Game 2300 and providing various other links for navigation to related information and functions within the Game-specific portion of the website 2302, provides a listing of the current Game standings 2304 and Rights allocations 2306, a summary of recent activity within the Game 2308, and an abbreviated list of pending offers by or to the user accessing the Game-specific home page 2310, with related links to directly take specific actions with respect to those offers 2312. Other links from the Game-specific home page include Trade 2314, Settings 2316, Auction 2318 and Market 2320, among others.

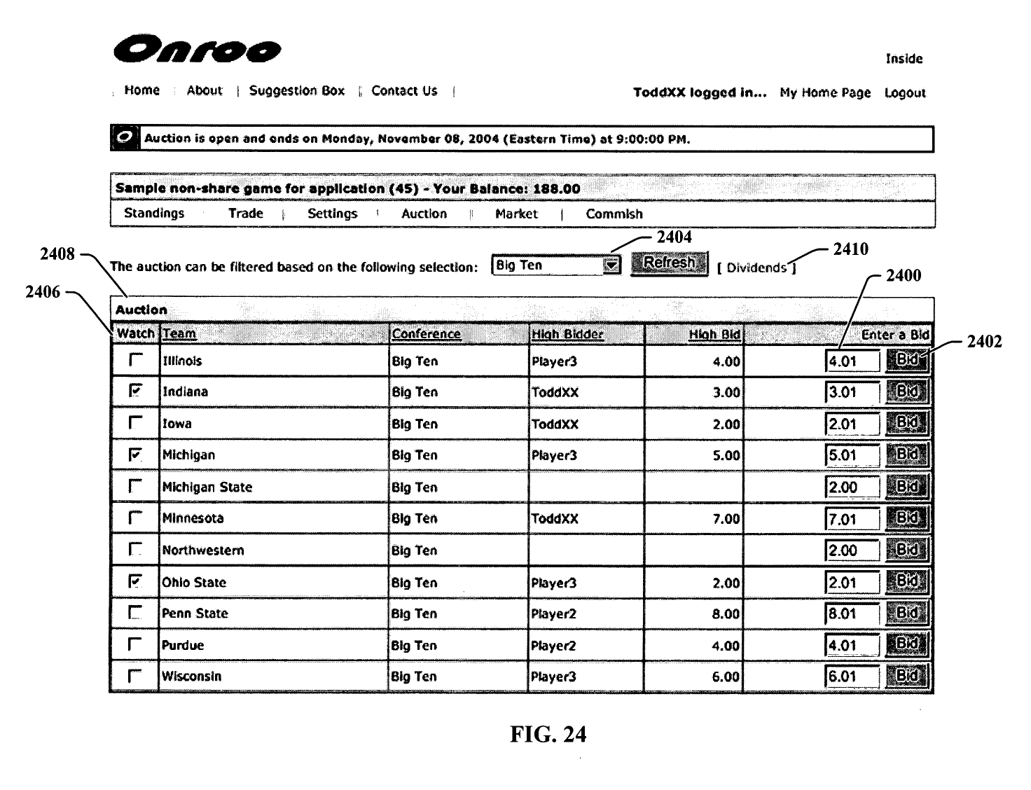

FIG. 24 illustrates a screenshot of the auction webpage for the Game. In addition to showing various information and options, the auction webpage includes interactive functionality that allows users to submit bids for Rights that are subject to initial allocation procedures through the auction. Users can submit bids by entering the amount of the bid in the bid box 2400 and clicking on the “Bid” button 2402. The view of the Rights being auctioned (in this case, all Rights with respect to each team are bundled together for allocation as described herein and such Rights are generally given the label of the related team) on the auction webpage can be filtered by the user using a drop-down menu 2404 which presents filtering based on various categories or other characteristics of the Rights or the auction.

For example, the view can be filtered to show all the teams in a given conference or league, all the teams on which bids have been submitted, all the teams being auctioned or other information. A user-defined filter is also provided which allows user to designate a team as part of the user's “Watch List” by checking a related box 2406, which list of teams can then be filtered and viewed separately from other teams. The auction webpage presents, depending on the filter selected by the user, an auctions area 2408 that shows the highest bids for the teams, the name of the highest bidder, and the high bid amount. The auction webpage also provides a “pop-up” listing of the Dividend Events and Dividends in the Game that is user-activated 2410.

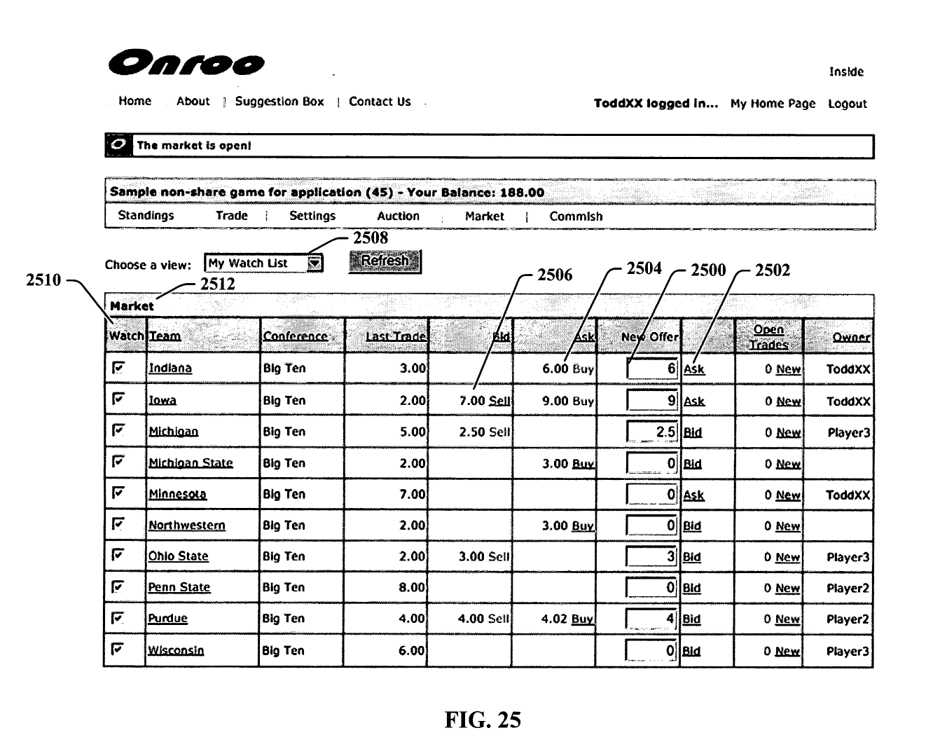

FIG. 25 illustrates a screenshot of the market webpage for the Game. In addition to showing various information and options, the market webpage includes interactive functionality that allows users to submit bid or ask prices for Rights allocated to other users. Users can submit or modify offers by entering the amount of the bid in the empty box 2500 and clicking on the “Bid” or “Ask” link 2502. Depending on whether the player is the owner of the Rights with respect to the team, the system automatically presents the appropriate option. The market webpage also presents links that allow the user to “Buy” 2504 or ““Sell” 2506 Rights directly if the user finds an offer presented that the user wishes to accept. The view of the Rights in the market (in this case, all Rights with respect to each team are bundled together as described herein and such Rights are generally given the label of the related team) on the market webpage can be filtered by the user using a drop-down menu 2508 in a manner similar to that described in the immediately preceding paragraph with respect to filtering of the view of Rights on the auction webpage, including through a Watch List 2510. The market webpage presents, depending on the filter selected by the user, a market area 25124 that shows the last price at which a team was exchanged, the current high bids for the teams, the current asking price for the team, and the name of the owner. The market webpage can also provide a “pop-up” listing of the Dividend Events and Dividends in the Game. The market webpage presents links to various other pages present related information and functionality.

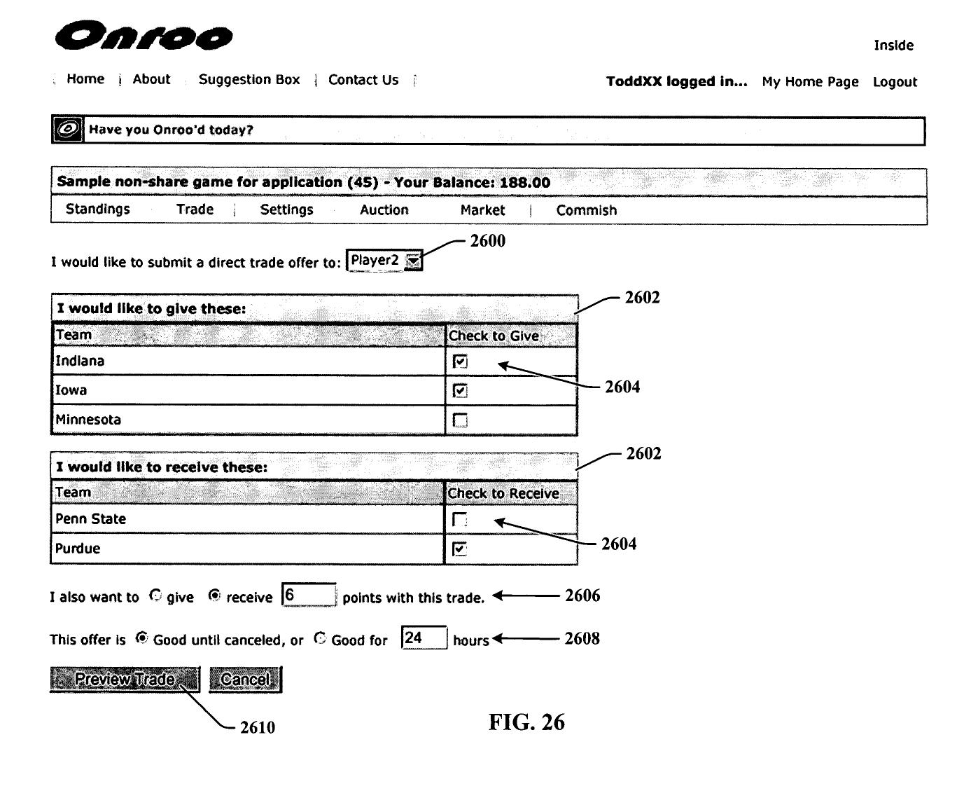

FIG. 26 illustrates a screenshot of a trade webpage on which a user in the Game can submit an offer of a direct trade of Rights (in this case, teams) to another user participating in the Game. The trade webpage contains a drop-down menu 2600 that the user can use to select from among the other players participating in the Game the player with whom the user would like to make a direct trade. Once the trade offered is selected, the trade webpage presents listings 2602 of the Rights owned by the user and the offeree and provides through a check-box selection 2604 a method for the user to indicate the direct trade being offered. The trade webpage also allows the user to include an exchange of points, either to or from the offeree depending on the selection of the user 2606 and determine the amount of time the offer will remain outstanding 2608. Once the user is satisfied with the selection of the terms of the direct trade being proposed, the user can click the “Preview Trade” 2610 button to preliminarily submit the trade.

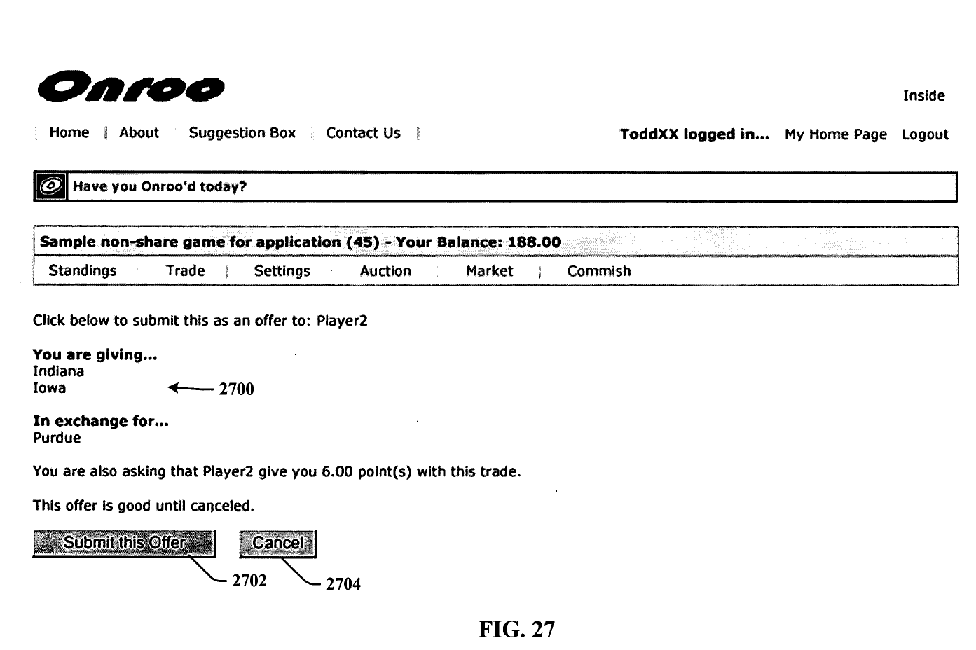

FIG. 27 illustrates a screenshot of a trade confirmation webpage on which a user can view the details 2700 of a direct trade that the user has preliminarily submitted by clicking the “Preview Trade” button 2610. The trade confirmation webpage presents the details of the trade and presents the user with buttons to either “Submit this Offer” 2702 or “Cancel” 2704. If the user decides to submit the offer, the trade offer will be presented and available for the offeree to accept through other pages in the Game-specific portion of the website.

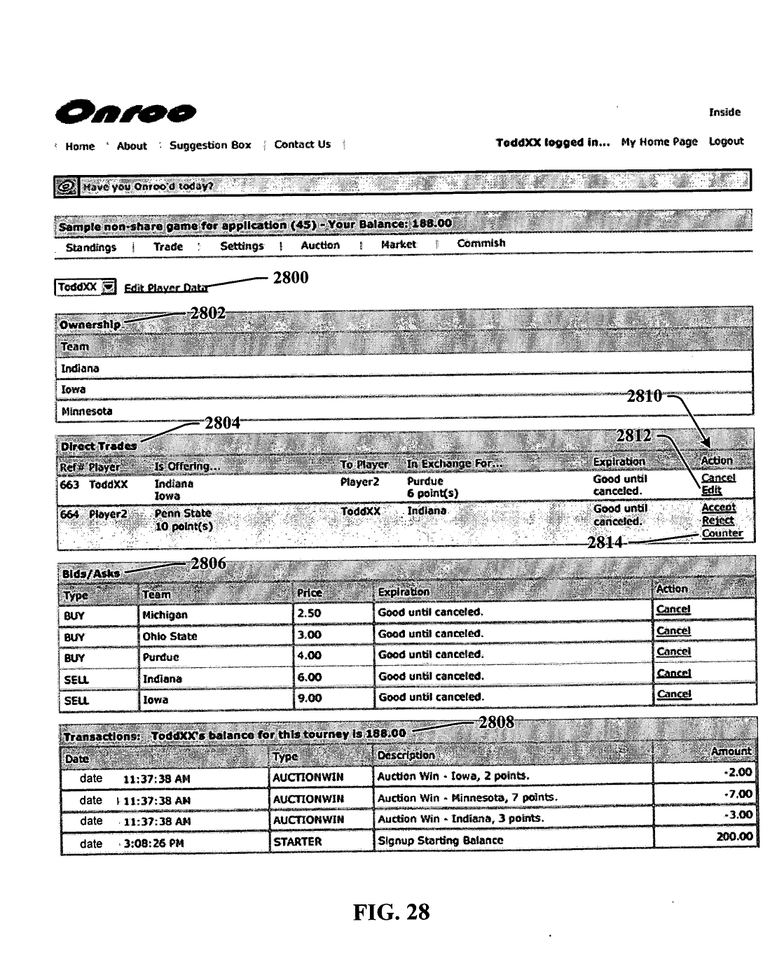

FIG. 28 illustrates a screenshot of a player summary webpage. The player summary webpage contains a drop-down menu 2800 that the user can use to select from among the players participating in the Game the player whose summary information the user wishes to view. The player summary webpage presents information for the selected player regarding Rights ownership 2802, complete lists of direct trade offers by or to the player 2804 and bid and ask offers made by the player 2806, in each case with related links to directly take specific actions with respect to those offers in which the user is involved as either the offeror or offeree, and a complete listing of all transactions within the Game in which the selected player has been involved 2808.

One feature that is particularly important on the player summary page (and which is also available on the Game-specific home page with respect to offers that are presented on that page in the abbreviated listing) is that players can accept, reject, modify or counter offers through links 2810 placed conveniently proximate to the presentation of the information regarding the offers on the display. In particular, the “Edit” 2812 and “Counter” 2814 features facilitate negotiation between players of direct trades by automatically linking to a direct trade webpage that has the trade-specific information filled in by default. In order to modify or counter the offer, then, the user must simply change the terms and submit or resubmit the trade offer. This procedure maximizes the efficiency with which a user can modify or counter trade offers and permits the user to avoid clicking through one or more steps to get to a direct trade webpage and then resubmit the information regarding the current trade.

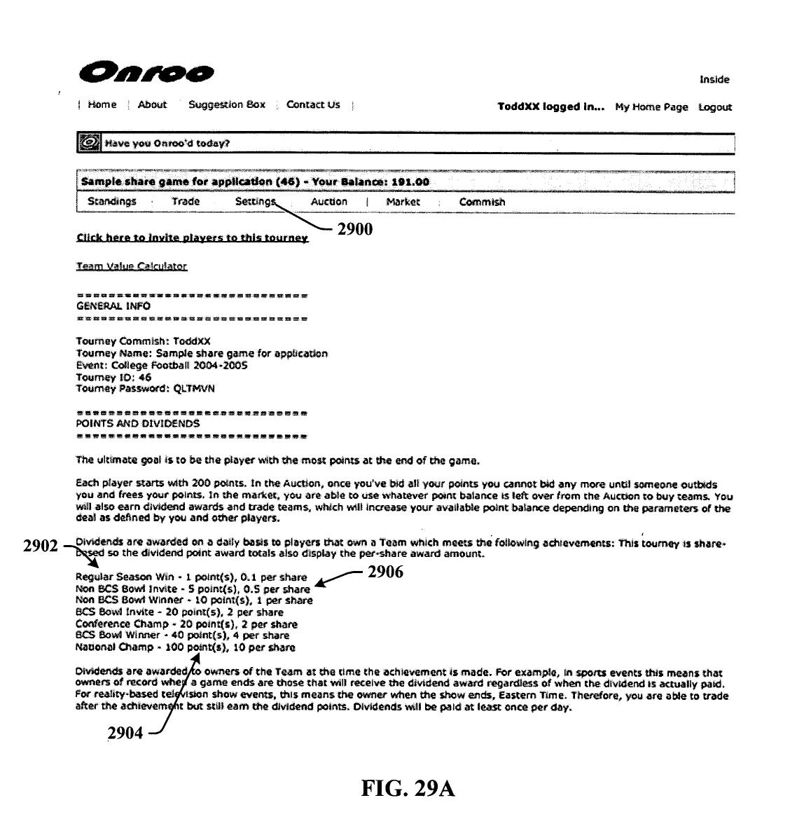

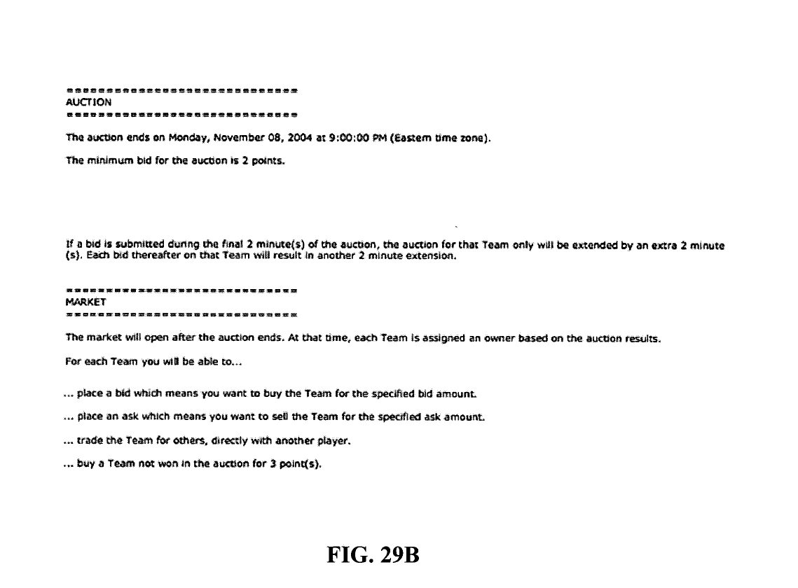

FIG. 29A through FIG. 37 illustrate screenshots of webpages within the Game-specific portion of the Site for a Game within the format of the subject invention in which certain Rights related to Dividend Events with respect to certain teams competing in an Event are owned separately as described herein. In the Game reflected in the webpages illustrated by FIG. 29A through FIG. 37, the right to receive Dividends upon the occurrence of a Dividend Event with respect to each team in the Event has been divided into 10 separate Rights, or shares.

FIG. 29A and FIG. 29B illustrate portions of a screenshot of a webpage that provides detailed information with respect to the particular Game. This information is accessible through links made available on various other webpages within the Game-specific portion of the website (e.g., under the “Settings” link 2900) and includes combined information relating to the Game Configuration and options selected by the Commissioner. The webpage includes the tournament status bar, a list of applicable Dividend Events 2902 and Dividend amounts 2904, and “per-share” awards 2906. Various other Game properties are presented as well.

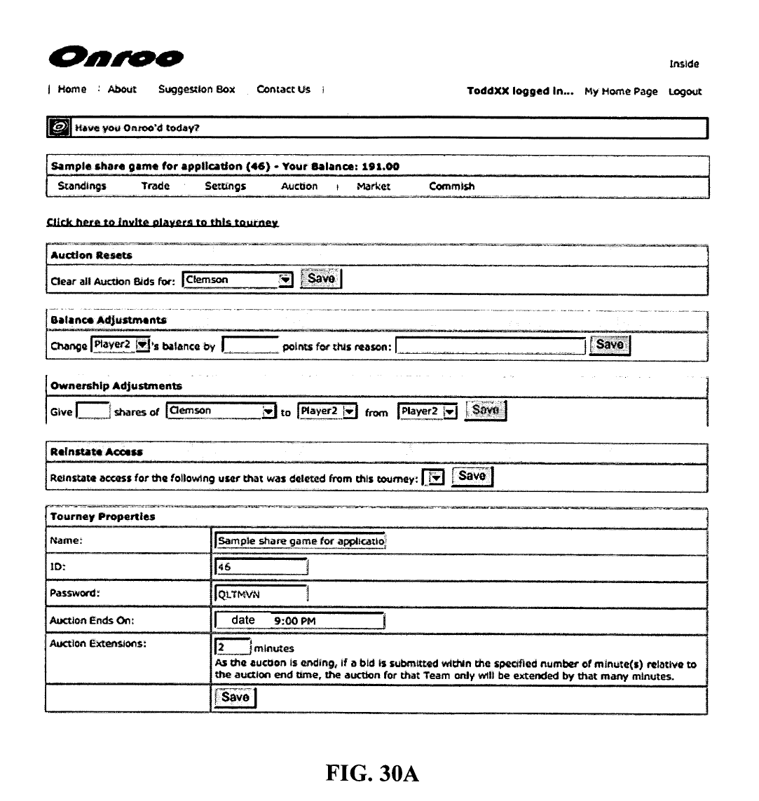

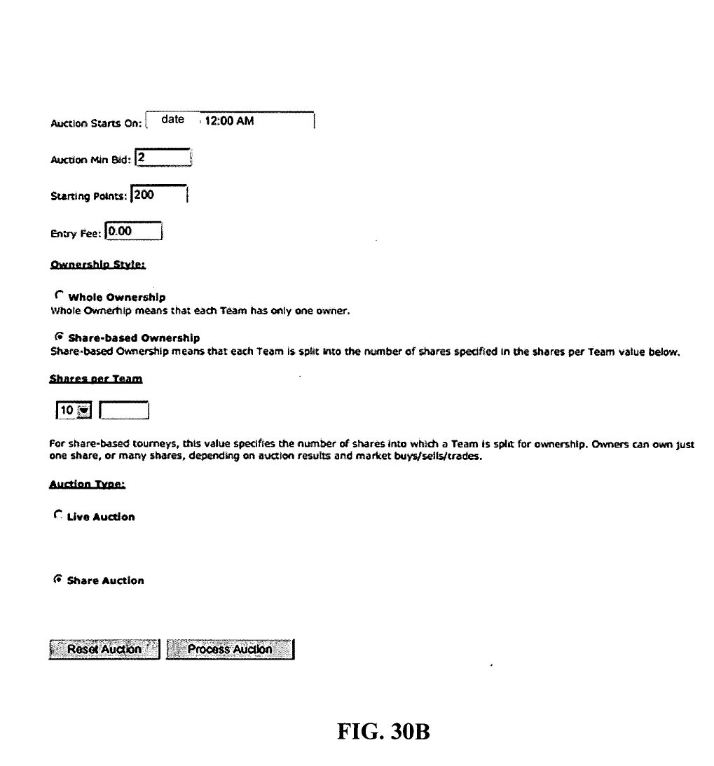

FIG. 30A and FIG. 30B illustrate portions of a screenshot of a webpage through which a user who is the Commissioner of the Game can view and modify certain Game Configuration options and other information relating to the Game.

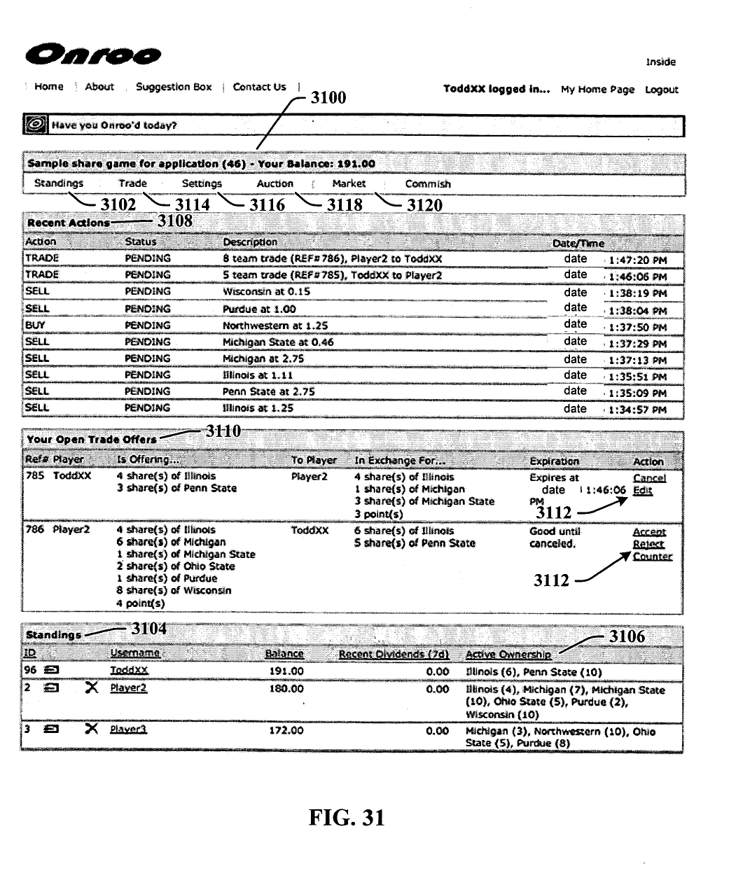

FIG. 31 illustrates a screenshot of a Game-specific home webpage of the Game. The Game-specific home webpage for a Game, in addition to identifying the subject Game 3100 and providing various other links for navigation to related information and functions within the Game-specific portion of the website 3102, provides a listing of the current Game standings 3104 and Rights allocations 3106, a summary of recent activity within the Game 3108, and an abbreviated list of pending offers by or to the user accessing the Game-specific home page 3110, with related links to directly take specific actions with respect to those offers 3112. Other links from the Game-specific home page include Trade 3114, Settings 3116, Auction 3118, and Market 3120, among others.

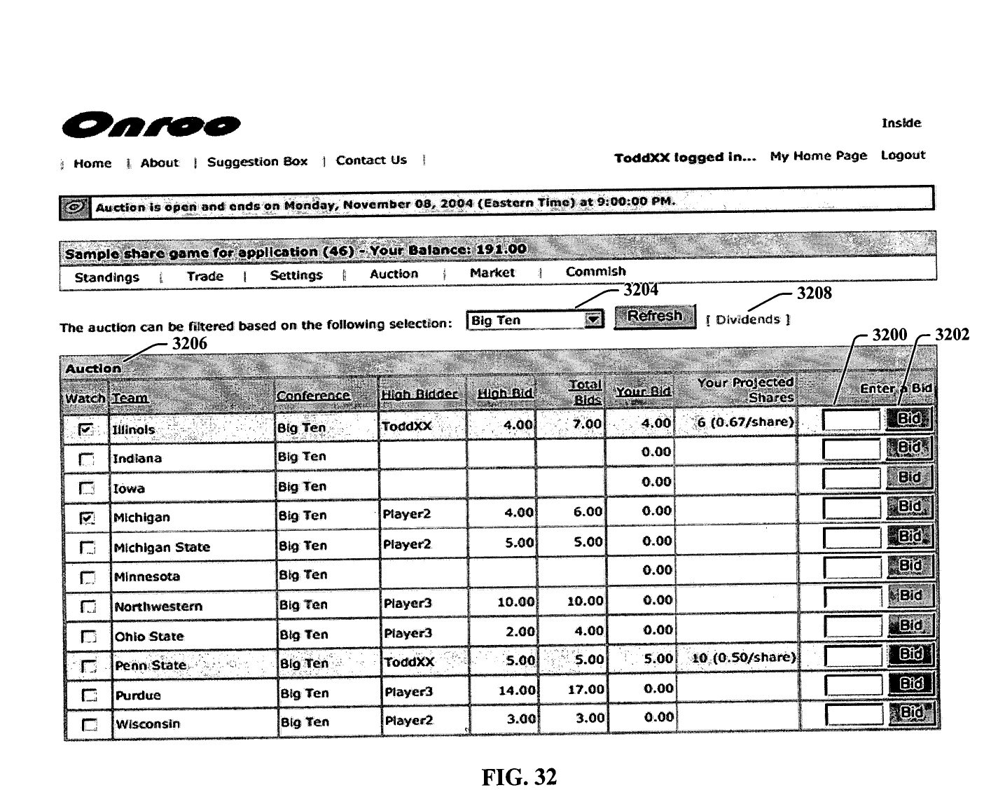

FIG. 32 illustrates a screenshot of the auction webpage for the Game. In addition to showing various information and options, the auction webpage includes interactive functionality that allows users to submit bids for Rights that are subject to initial allocation procedures through the auction. Users can submit bids by entering the amount of the bid in the empty bid box 3200 and clicking on the “Bid” button 3202. The view of the Rights being auctioned on the auction webpage can be filtered by the user using a drop-down menu 3204 as described above with respect to FIG. 24, including the “Watch List”. The auction webpage presents, depending on the filter selected by the user, an auctions area 3206 that shows the highest bids for the Rights with respect to a team, the name of the highest bidder, and the total amount of all bids for a the Rights with respect to a team, and the user's project shares using applicable auction processing rules as determined by the Game Configuration. The auction webpage also provides a “pop-up” listing of the Dividend Events and Dividends in the Game that is user-activated 3208.

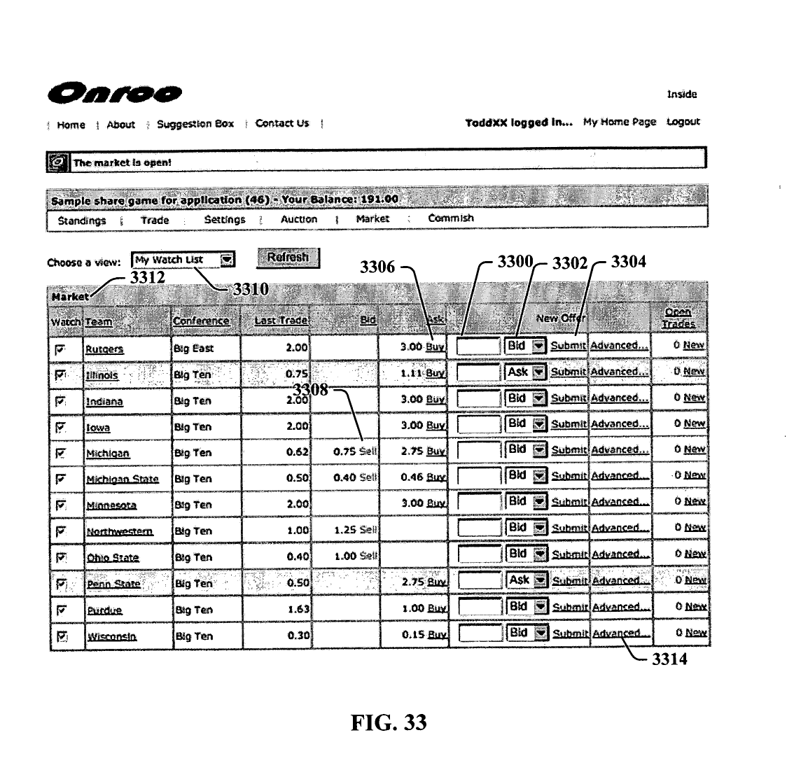

FIG. 33 illustrates a screenshot of the market webpage for the Game. In addition to showing various information and options, the market webpage includes interactive functionality that allows users to submit bid or ask prices for Rights allocated to other users. Users can submit or modify offers by entering the amount of the bid in the empty box 3300, selection the applicable choice from the “Bid” or “Ask” drop-down menu 3302, and clicking the “Submit” link 3304. A drop-down menu 3302 allows the player to select whether the offer is a bid or an ask offer for the subject Right. The market webpage also presents links that allow the user to “Buy” 3306 or “Sell” 3308 Rights directly if the user finds an offer presented that the user wishes to accept.

The view of the Rights in the market on the market webpage can be filtered by the user using a drop-down menu 3310 in a manner similar to that described in the immediately preceding paragraph with respect to filtering of the view of Rights on the auction webpage. The market webpage presents, depending on the filter selected by the user, a market area 3312 that shows the last price at which a Right with respect to a team was exchanged, the current high bids for one or more Rights with respect to each team, and the current asking price for one or more Rights with respect to each team. The market webpage can also provide a “pop-up” listing of the Dividend Events and Dividends in the Game. The market webpage presents links to various other pages present related information and functionality. The market webpage also include an “Advanced” Link 3314 which allows a user to submit a bid or an ask offer with specified terms.

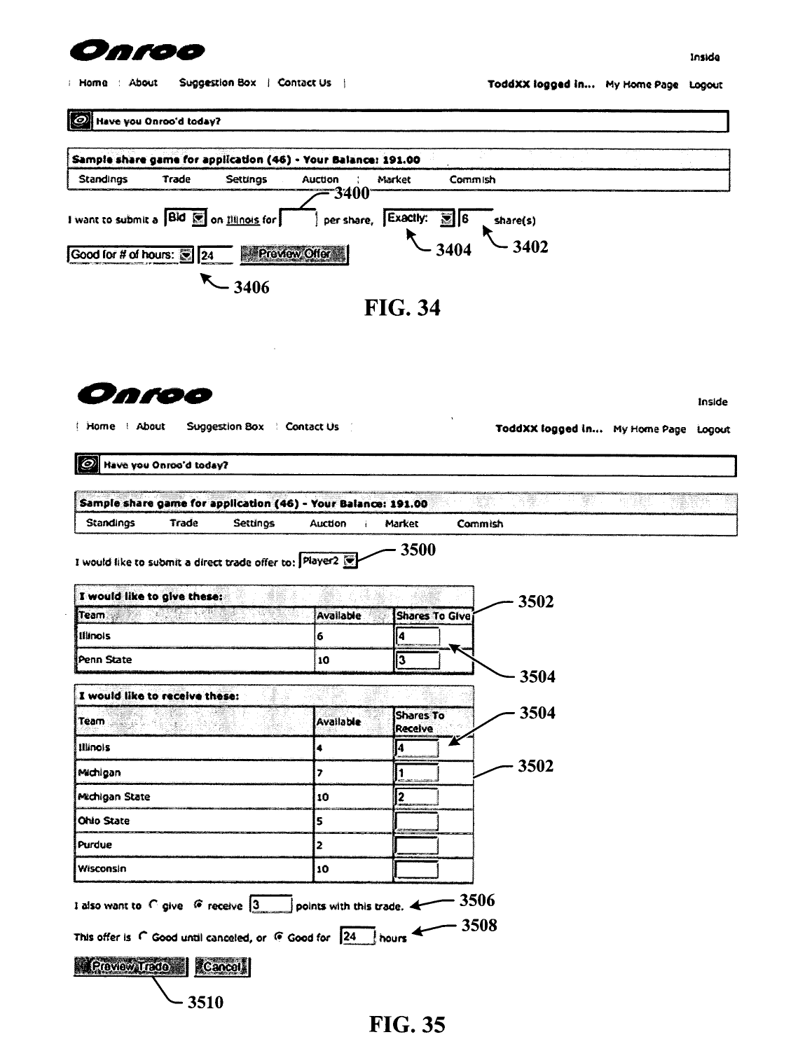

FIG. 34 illustrates a screenshot of an advanced offer webpage which allows a user to submit a bid or an ask offer with specified terms including a price per Rights (or share) 3400, the number of Rights (or shares) in the offer 3402, a drop-down menu allowing a user to select whether less than the specified number of shares will be accepted 3404, and the length of time for which the offer will be outstanding 3406.

FIG. 35 illustrates a screenshot of a trade webpage on which a user in the Game can submit an offer of a direct trade of Rights (in this case, shares) to another user participating in the Game. The trade webpage contains a drop-down menu 3500 that the user can use to select from among the other players participating in the Game the player with whom the user would like to make a direct trade. Once the trade offeree is selected, the trade webpage presents listings 3502 of the Rights (or shares) owned by the user and the offeree and provides through an entry-box selection 3504 a method for the user to indicate the direct trade being offered. The trade webpage also allows the user to include an exchange of points, either to or from the offeree depending on the selection of the user 3506 and determine the amount of time the offer will remain outstanding 3508. Once the user is satisfied with the selection of the terms of the direct trade being proposed, the user can click the “Preview Trade” 3510 button to preliminarily submit the trade.

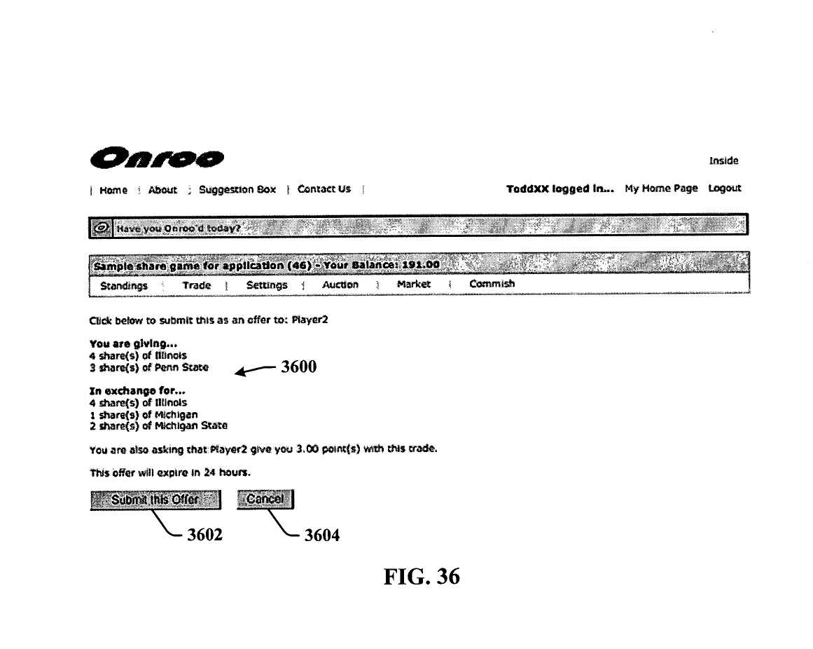

FIG. 36 illustrates a screenshot of a trade confirmation webpage on which a user can view the details 3600 of a direct trade that the user has preliminarily submitted by clicking the “Preview Trade” button 3510. The trade confirmation webpage presents the details of the trade and presents the user with buttons to either “Submit this Offer” 3602 or “Cancel” 3604. If the user decides to submit the offer, the trade offer will be presented and available for the offeree to accept through other pages in the Game-specific portion of the website.

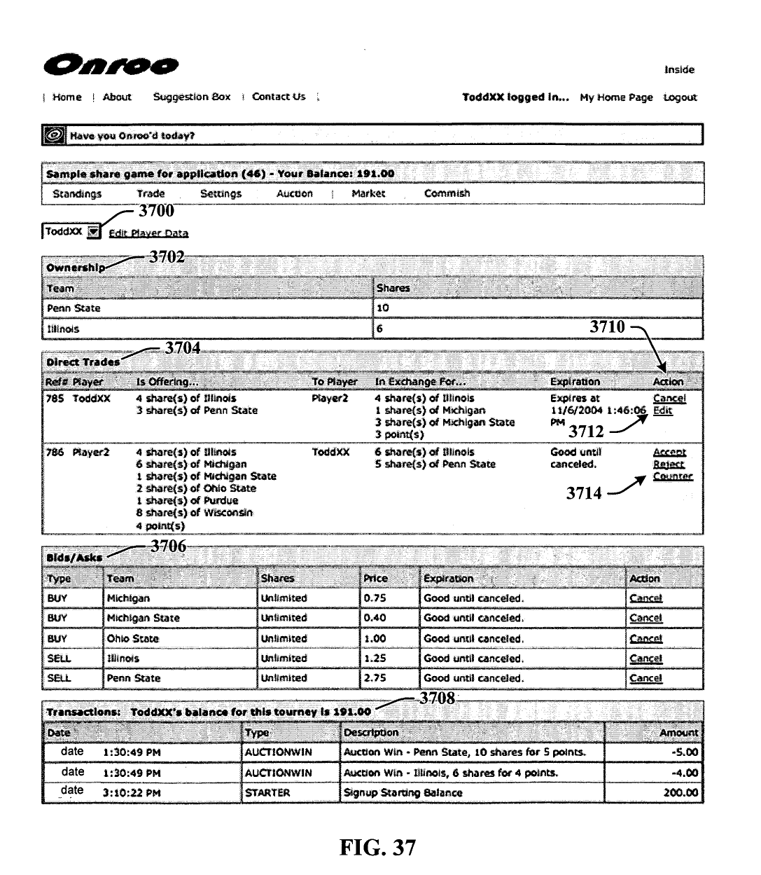

FIG. 37 illustrates a screenshot of a player summary webpage. The player summary webpage contains a drop-down menu 3700 that the user can use to select from among the players participating in the Game the player whose summary information the user wishes to view. The player summary webpage presents information for the selected player regarding Rights ownership 3702, complete lists of direct trade offers by or to the player 3704 and bid and ask offers made by the player 3706, in each case with related links to directly take specific actions with respect to those offers in which the user is involved as either the offeror of offeree, and a complete listing of all transactions within the Game in which the selected player has been involved 3708. As described above with regard to FIG. 28, through the player summary page (and on the Game-specific home page with respect to offers that are presented on that page in the abbreviated listing) players can accept, reject, modify or counter offers through links 3710 placed conveniently proximate to the presentation of the information regarding the offers on the display, including the “Edit” 3712 and “Counter” 3714 features.

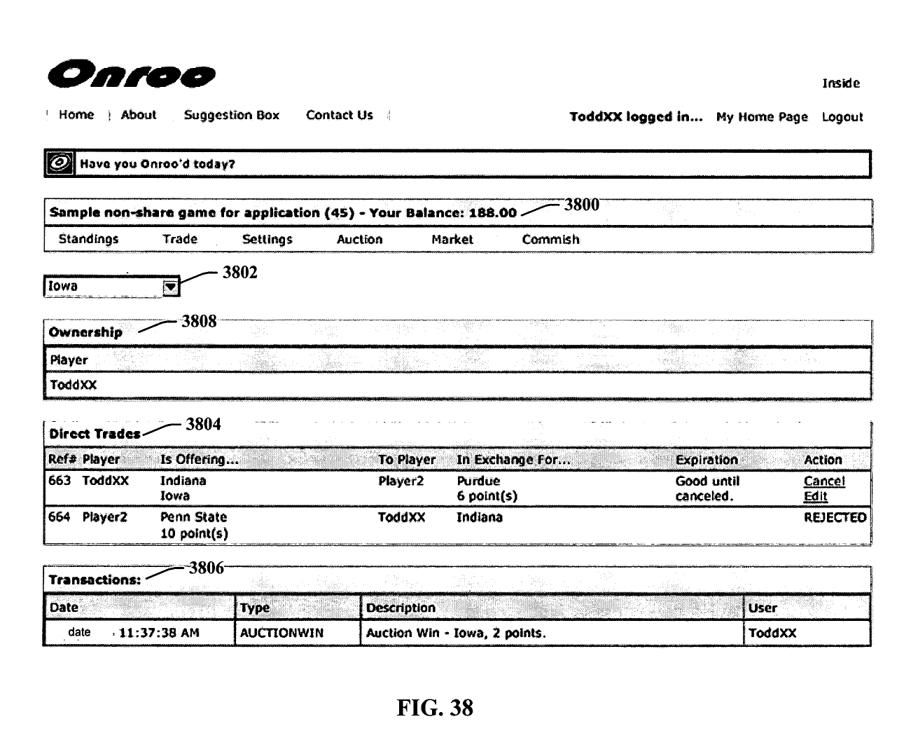

FIG. 38 illustrates a screenshot of a Rights summary webpage of the invention. The tournament status bar 3800 is shown, along with a drop-down menu 3802 to select the Right for which information is to be displayed, together with information regarding direct trades involving the Rights 3804 and transactions involving the Rights 3806 and the player or players to whom such Rights are currently allocated.

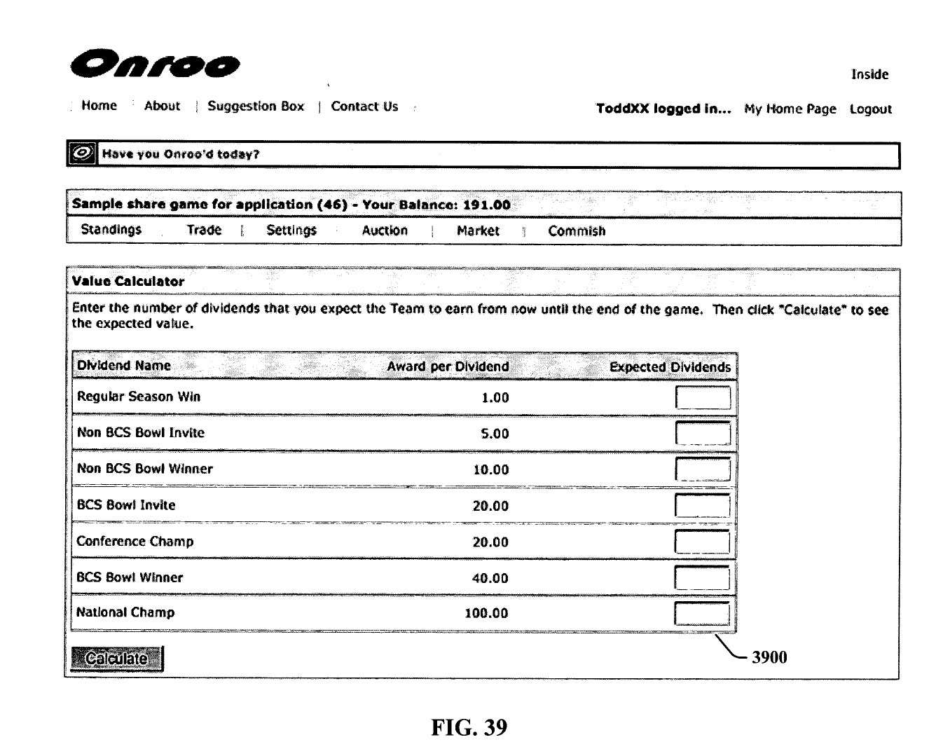

FIG. 39 illustrates a screenshot of a Rights value calculator webpage in accordance with the invention. The calculator assists users in determining values for particular Rights by allowing users to input their opinions in data boxes 3900 regarding the likelihood of various Dividend Events with respect to various Rights occurring and then processing that information in light of the applicable Game Configuration. As with any of the webpages or processes described herein, the look, graphics, design, options, and functionality of Rights calculators can vary significantly according to conventional design techniques, interactive options, and website enhancements, particularly, in the case of Rights calculations through integration of real world data into the value processing procedures.

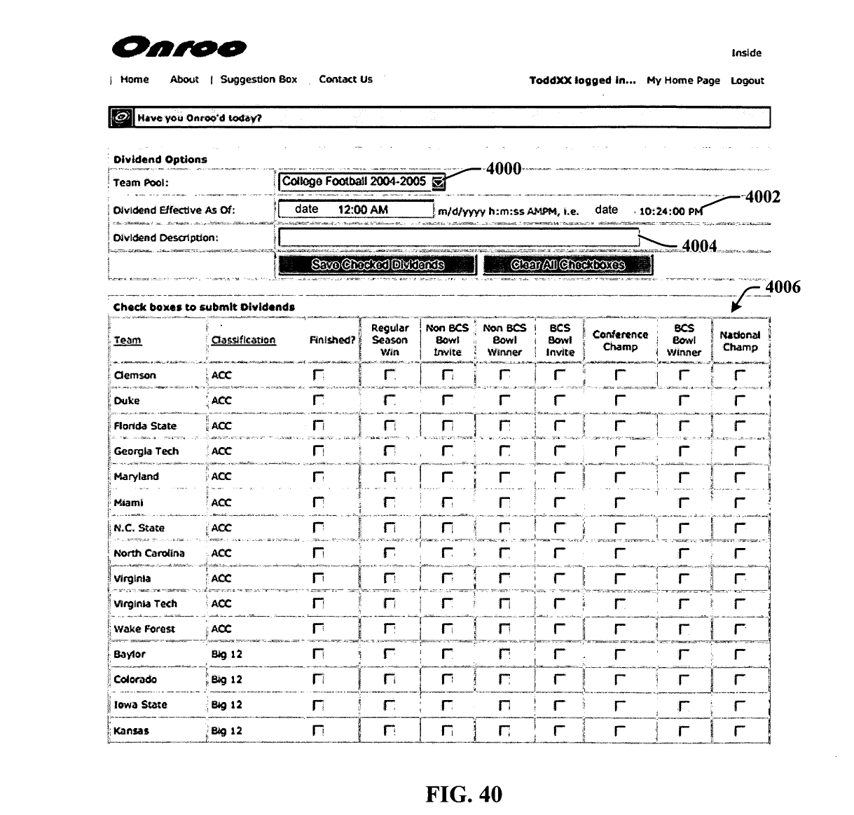

FIG. 40 illustrates a screenshot of a data entry webpage through which an administrator can enter Event results data in order for such data to be processed by the system in accordance with the applicable Game Configuration in accordance with one implementation of the invention. The data entry web page includes a drop-down menu 4000 to select the Game Configuration with respect to which the date to be entered relates, a time entry box 4002 to permit Dividend awards based on the entered data to be effective as of a specified time, a description box 4004, and several data entry check boxes 4006 which permit administrators to enter Event data to be processed throughout each Game being played within the applicable Game Configuration. The website can be configured such that such Event data entry is automated through any one or more available processes.

Additional webpages and links can be employed to facilitate the gaming experience. For example, additional welcome pages can be provided along with rules pages which are easy to access and understand. Moreover, Message Boards or forums can be provided to allow Game-specific or general player and user messaging (e.g., Instant Messaging). Commissioners can enter a URL (Uniform Resource Locator) link to a bulletin board that they have set up for their game. An automated invitation system (including by email or otherwise) can be made available through which invitees are automatically notified and invited to participate in a Game.

The website can also provide a general set of topical bulletin boards where serious players can discuss strategy, etc. Furthermore, access to the bulletins boards can be restricted to players of a certain Game or Games within a Game Configuration, for example. Other implementations to the website interface can include Game-specific procedures for review of fairness of exchanges through a player voting mechanism. Another website implementation can include a “What are my options?” button or link or the like that will offer suggestions to beginners about strategic actions they might take to enhance their chances of winning.

Other implementation include integration of real world date with respect to an Event into the information presented through various pages on the website to assist user strategic decision-making, including Event standings or rankings and past Dividend history for certain bundled Rights and other information.

The game software can be configured to notify existing players of any pending activity in the Game, or to notify prospective players to entice them to subscribe to a Game. For example, if an offer to sell a Right for 10 points is submitted, a communication (e.g., an e-mail or other message type such as Instant Message (IM) or Short Service Message (SSM) can be sent to anyone participating as a player in the tournament or to only such players as have requested such a notification. Through this notification process, players can be notified via their cell phone, PDA, etc., anytime an event that they have requested notification regarding occurs. Some events that can trigger notifications include ask or bid offers, exchanges of Rights, direct trade proposals, executions, revocations, modifications and counteroffers, Dividend awards and the like, for example.

Exemplary Gaming Client and/or Server Platform

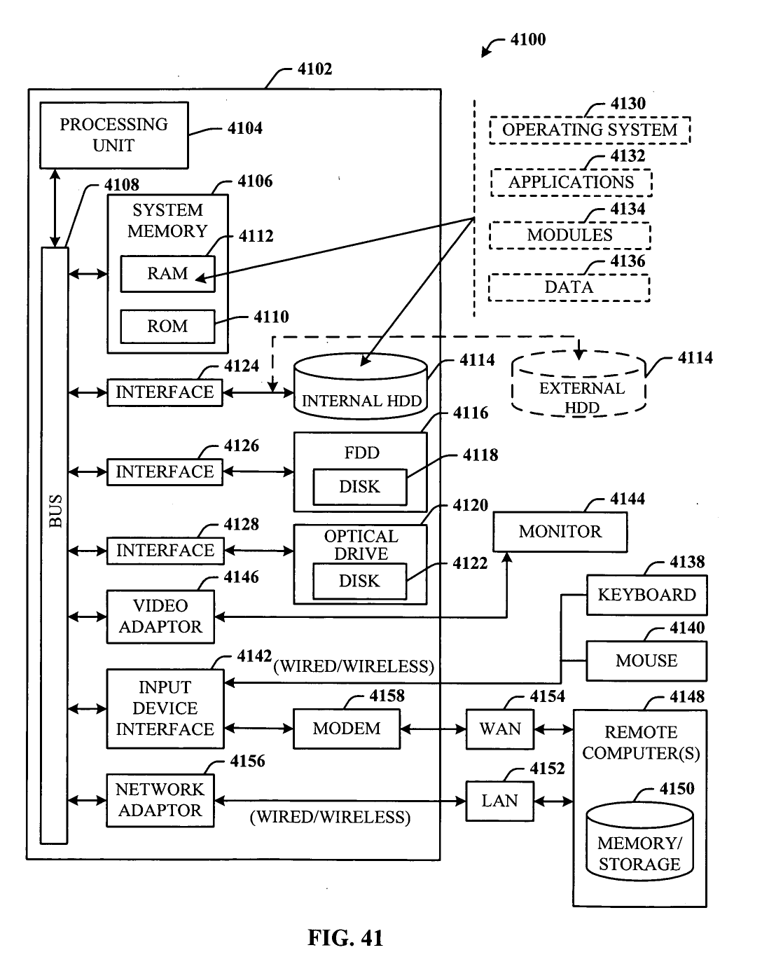

Referring now to FIG. 41, there is illustrated a block diagram of a computer operable to execute the disclosed architecture. In order to provide additional context for various aspects of the subject invention, FIG. 41 and the following discussion are intended to provide a brief, general description of a suitable computing environment 4100 in which the various aspects of the invention can be implemented. While the invention has been described above in the general context of computer-executable instructions that may run on one or more computers, those skilled in the art will recognize that the invention also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the invention may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer readable media can comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 41, there is illustrated an exemplary environment 4100 for implementing various aspects of the invention that includes a computer 4102, the computer 4102 including a processing unit 4104, a system memory 4106 and a system bus 4108. The system bus 4108 couples system components including, but not limited to, the system memory 4106 to the processing unit 4104. The processing unit 4104 can be any of various commercially available processors. Dual microprocessors and other multi-processor architectures may also be employed as the processing unit 4104.

The system bus 4108 can be any of several types of bus structure that may further interconnect to a memory bus (with or without a memory controller), a peripheral bus, and a local bus using any of a variety of commercially available bus architectures. The system memory 4106 includes read only memory (ROM) 4110 and random access memory (RAM) 4112. A basic input/output system (BIOS) is stored in a non-volatile memory 4110 such as ROM, EPROM, EEPROM, which BIOS contains the basic routines that help to transfer information between elements within the computer 4102, such as during start-up. The RAM 4112 can also include a high-speed RAM such as static RAM for caching data.

The computer 4102 further includes an internal hard disk drive (HDD) 4114 (e.g., EIDE, SATA), which internal hard disk drive 4114 may also be configured for external use in a suitable chassis (not shown), a magnetic floppy disk drive (FDD) 4116, (e.g., to read from or write to a removable diskette 4118) and an optical disk drive 4120, (e.g., reading a CD-ROM disk 4122 or, to read from or write to other high capacity optical media such as the DVD). The hard disk drive 4114, magnetic disk drive 4116 and optical disk drive 4120 can be connected to the system bus 4108 by a hard disk drive interface 4124, a magnetic disk drive interface 4126 and an optical drive interface 4128, respectively. The interface 4124 for external drive implementations includes at least one or both of Universal Serial Bus (USB) and IEEE 1394 interface technologies.

The drives and their associated computer-readable media provide nonvolatile storage of data, data structures, computer-executable instructions, and so forth. For the computer 4102, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the invention.

A number of program modules can be stored in the drives and RAM 4112, including an operating system 4130, one or more application programs 4132, other program modules 4134 and program data 4136. All or portions of the operating system, applications, modules, and/or data can also be cached in the RAM 4112. It is appreciated that the invention can be implemented with various commercially available operating systems or combinations of operating systems.

A user can enter commands and information into the computer 4102 through one or more wired/wireless input devices, e.g., a keyboard 4138 and a pointing device, such as a mouse 4140. Other input devices (not shown) may include a microphone, an IR remote control, a joystick, a game pad, a stylus pen, touch screen, or the like. These and other input devices are often connected to the processing unit 4104 through an input device interface 4142 that is coupled to the system bus 4108, but can be connected by other interfaces, such as a parallel port, an IEEE 1394 serial port, a game port, a USB port, an IR interface, etc.

A monitor 4144 or other type of display device is also connected to the system bus 4108 via an interface, such as a video adapter 4146. In addition to the monitor 4144, a computer typically includes other peripheral output devices (not shown), such as speakers, printers, etc.

The computer 4102 may operate in a networked environment using logical connections via wired and/or wireless communications to one or more remote computers, such as a remote computer(s) 4148. The remote computer(s) 4148 can be a workstation, a server computer, a router, a personal computer, portable computer, microprocessor-based entertainment appliance, a peer device or other common network node, and typically includes many or all of the elements described relative to the computer 4102, although, for purposes of brevity, only a memory storage device 4150 is illustrated. The logical connections depicted include wired/wireless connectivity to a local area network (LAN) 4152 and/or larger networks, e.g., a wide area network (WAN) 4154. Such LAN and WAN networking environments are commonplace in offices, and companies, and facilitate enterprise-wide computer networks, such as intranets, all of which may connect to a global communication network, e.g., the Internet.

When used in a LAN networking environment, the computer 4102 is connected to the local network 4152 through a wired and/or wireless communication network interface or adapter 4156. The adaptor 4156 may facilitate wired or wireless communication to the LAN 4152, which may also include a wireless access point disposed thereon for communicating with the wireless adaptor 4156.

When used in a WAN networking environment, the computer 4102 can include a modem 4158, or is connected to a communications server on the WAN 4154, or has other means for establishing communications over the WAN 4154, such as by way of the Internet. The modem 4158, which can be internal or external and a wired or wireless device, is connected to the system bus 4108 via the serial port interface 4142. In a networked environment, program modules depicted relative to the computer 4102, or portions thereof, can be stored in the remote memory/storage device 4150. It will be appreciated that the network connections shown are exemplary and other means of establishing a communications link between the computers can be used.

The computer 4102 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

Referring now to FIG. 42, there is illustrated a schematic block diagram of an exemplary computing environment 4200 in accordance with the subject invention. A global communications network (GCN) 4202 facilitates user communication between game server 4204 and multiple different types of clients. For example, a first client connects to the game server 4204 via a desktop computer 4206. A second client communicates wirelessly to the game server 4204 via a PDA (Personal Digital Assistant) 4208, a third client connects wirelessly via a cellular telephone 4210, a fourth client via a laptop computer 4212 and a fifth client via a TabletPC 4214. These are only but a few of the ways in which game players and commissioners can connect remotely to interact with the game, and non-players can access the game website to view further information. The game server 4204 can run multiple games simultaneously, denoted as GAME₁, . . . ,GAME_{N}.

In one implementation, the administrator (or commissioner) inputs RLE data manually into the game server 4204 such that the running games can perform as described supra. In another implementation, each RLE is associated with an RLE server that automatically communicates or is polled by the game server 4204 for the RLE data. For example, a first game (GAME₁) can be associated with a first RLE (denoted RLE₁), and to which is associated an RLE₁ server 4216. Similarly, an Nth game (GAME_{N}) is associated with an Nth RLE_{N}, and which provides network capability via an Nth RLE_{N} server 4218. Thus, the commissioner (or game server administrator) need not manually enter all of the most current RLE data manually.

In support thereof, the system 4200 includes the one or more client(s), which can be hardware and/or software (e.g., threads, processes, computing devices). The client(s) 4202 can house cookie(s) and/or associated contextual information by employing the invention, for example.

The system 4200 also includes the one or more server(s). The server(s) can also be hardware and/or software (e.g., threads, processes, computing devices), and can house threads to perform transformations by employing the invention, for example. One possible communication between a client and a server can be in the form of a data packet adapted to be transmitted between two or more computer processes. The data packet may include a cookie and/or associated contextual information, for example. The system 4200 includes the communication framework GCN 4202 (e.g., the Internet) that can be employed to facilitate communications between the client(s) and the server(s).

As indicated, communications can be facilitated via a wired (including optical fiber) and/or wireless technology. The client(s) can be operatively connected to one or more client data store(s) (not shown) that can be employed to store information local to the client(s) (e.g., cookie(s) and/or associated contextual information). Similarly, the server(s) are operatively connected to one or more server data store(s), e.g., a data store 4220 that can be employed to store information local thereto.

In another implementation, the game software facilitates financial transactions such that the game is not only played with points, but the points, final standing, and intermediate objectives are rewarded in terms of money. Thus, when a user registers to play one or more games, personal account information can be input such that the player's performance has a financial impact on a player account. In support thereof, the system 4200 also includes a banking and/or credit card servers, denoted collectively as a player accounts server 4222, which facilitates accessing the player financial accounts and crediting or debiting such accounts accordingly, in relation to the player's performance in the game and for various aspects thereof.

What has been described above includes examples of the invention. It is, of course, not possible to describe every conceivable combination of components or methodologies for purposes of describing the subject invention, but one of ordinary skill in the art may recognize that many further combinations and permutations of the invention are possible. Accordingly, the invention is intended to embrace all such alterations, modifications and variations that fall within the spirit and scope of the appended claims. For example, it is not necessary that the game be played on a computer. In other words, the game can be played as a board game with all aspects such as auctions and market-based transactions between players performed, for example, in a less convenient manner than that facilitated by a computer and a computer network. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates a game, comprising:
a rights allocation component of the game that allows allocation of rights to a player in the game for obtaining a right in an aspect associated with an event; and
a transaction component that allows performance of a transaction process during the game in association with the aspect.

2. The system of claim 1, wherein the right is associated with receiving value in the aspect of the event.

3. The system of claim 1, wherein the event is a real-life event (RLE).

4. The system of claim 2, wherein the RLE is associated with at least one of a sports event and a television program.

5. The system of claim 1, wherein the event is associated with event data that is input at least one of manually and automatically.

6. The system of claim 1, wherein the rights are allocated via one of an open auction, a blind auction, and a Dutch auction.

7. The system of claim 1, wherein the transaction process includes at least one of a buy, sell, and trade, and an offer to buy, sell, and trade.

8. The system of claim 1, wherein the event includes at least one of a pre-season, regular season, post-season, and playoff component.

9. The system of claim 1, wherein the game includes at least one of limited points and unlimited points for a player that facilitates the allocation of the rights and are for use during the transaction process.

10. The system of claim 1, wherein participation in the allocation of the rights can be performed using a proxy-style bid.

11. The system of claim 1, wherein the aspect includes ownership of rights to receive points upon an occurrence related to a team or a contestant, or additional rights upon the occurrence related to the team or the contestant.

12. The system of claim 1, wherein a player can participate in the allocation of the rights and the transaction process from a remote location.

13. The system of claim 1, further comprising an artificial intelligence (AI) component that employs a probabilistic and/or statistical-based analysis to prognose or infer an action that a user desires to be automatically performed.

14. The system of claim 1, wherein a commissioner presides over at least one of the allocation of rights and the transaction process to ensure equitability thereof.

15. A server that employs the system of claim 1.

16. The system of claim 1, wherein the event is associated with a single game.

17. The system of claim 1, wherein a bid on the aspect by a player is automatically processed during the allocation of rights without interaction by the player.

18. The system of claim 1, wherein at the completion of the event, a winner is determined.

19. The system of claim 1, wherein ownership of the aspect is at least one of individually and in combination with other rights.

20. A computer readable medium having stored thereon computer executable instructions for carrying out the system of claim 1.

21. A computer that employs the system of claim 1.

22. A system that facilitates an online game, comprising:
an event component that processes event data related to a RLE;
a rights allocation component that facilitates allocation of rights to a player in the game for obtaining a right to receive value in an aspect of the online game of the RLE based upon an occurrence associated with the RLE; and
a transaction component that allows performance of a transaction process which includes at least one of a buy, sell, or trade of the aspect and an offer to buy, sell or trade the aspect.

23. The system of claim 22, wherein the RLE is associated with at least one of a sports event and a television program.

24. The system of claim 22, wherein the transaction process occurs throughout duration of the RLE.

25. The system of claim 22, wherein rights obtained via the allocation of rights are shared among a plurality of different players on a pro rata basis.

26. The system of claim 22, wherein ownership obtained via the allocation of rights is limited to a subset of teams or contestants associated with the RLE.

27. The system of claim 22, further comprising an access component that facilitates interacting with the rights allocation component and the transaction component.

28. The system of claim 22, wherein the allocation of rights includes a process that prevents a bid by one player from being viewed by another bidding player.

29. The system of claim 22, wherein if ownership in combination with other rights occurs during the allocation of rights, the ownership in combination with other rights applies during the transaction process.

30. The system of claim 22, wherein if individual ownership occurs during the allocation of rights, at least one of individual ownership and ownership in combination with other rights applies during the transaction process.

31. The system of claim 22, wherein the allocation of rights includes an end time such that if a bid is received within a predetermined time window of the end time, the allocation of rights is extended for an additional period of time.

32. The system of claim 22, wherein the allocation of rights is a limited points auction that includes a reserve amount.

33. The system of claim 22, wherein at least one of a player and a winner of the game is rewarded financially.

34. The system of claim 22, wherein the RLE is associated with a private game in which a player can play by invitation only.

35. The system of claim 22, wherein the game public, such that a fixed number of public players can register and play.

36. A computer-readable medium having computer-executable instructions for performing a method of providing an online game, the method comprising:
bidding on an aspect of an event, which event is external to the game;
receiving event data associated with the event;
performing at least one of buying, selling, and trading the aspect of the event;
processing at least one of an offer to buy, sell, and trade the aspect of the event; and
determining a winner of the game at an end of the event.

37. The method of claim 36, the act of receiving comprises the acts of:
manually inputting the event data; and
automatically receiving the event data from a remote event source.

38. The method of claim 36, the act of bidding is performed according to one of an open auction, blind auction, Dutch auction, and draft auction.

39. The method of claim 36, the event is one of a sports event, a television program, and a computer-generated event.

40. The method of claim 36, further comprising providing a limited number of points for both of the act of bidding and the act of performing.

41. The method of claim 36, further comprising basing the event data on one or more of a pre-season, regular season, post-season, and playoff component.

42. The method of claim 36, further comprising processing a bid of a player without the player participating during the act of bidding.

43. The method of claim 36, further comprising communicating event data to a player via a player communications device.

44. The method of claim 36, further comprising receiving player instructions from a location that is remote from a game server that is running the game.

45. The method of claim 36, further comprising presenting targeted information to a player of the game.

46. The method of claim 36, further comprising awarding the aspect, which aspect is rights in ownership of a team or contestant, to a highest bid, which highest bid is one of a single player and a plurality of players.

47. The method of claim 36, further comprising limiting a number of aspects of the event which a player can own.

48. The method of claim 36, further comprising presenting in substantially real-time standings information, bid information, buying information, selling information, and trading information.

49. The method of claim 36, further comprising allowing the act of performing to continue throughout duration of the external event.

50. A system that facilitates a game, comprising:
a game configuration component that facilitates creation of a game configuration for the game to be played, which game is played in association with an event or series of events;
a rights allocation component that facilitates allocation to or ownership by the player, of rights; and
an event component that allows for input and processing of data according to the game configuration component and the right allocation component.

51. The system of claim 50, wherein the event or series of events is at least one of a RLE, and a fantasy event that is driven by a pseudo-random number generator.

52. The system of claim 51, wherein the RLE is associated with at least one of a sports event, a television program, a series thereof of the sports event or the television program, and a portion of the sports event or the television program.

53. The system of claim 51, wherein the RLE includes at least one of a pre-season, regular season, post-season, and playoff component.

54. The system of claim 50, wherein the game configuration allows defining at least one of an objective of the game with respect to the related RLE, sub-events upon which the rights and points will be allocated or awarded to players in the game, and the rights and amounts of the points to be allocated or awarded upon occurrence of each sub-event.

55. The system of claim 54, wherein the sub-events include any and all events that can occur during the RLE.

56. The system of claim 50, wherein the manner in which rights are allocated pursuant to the rights allocation component is at least one of individually and in combination with other rights.

57. The system of claim 50, wherein rights allocations to players are limited in accordance with the game configuration to a percentage or other subset of all rights available in the game.

58. The system of claim 50, wherein the rights allocation component allows for at least one of allocation of rights to players upon the rights first being made available in the game and an exchange of rights between players during the game.

59. The system of claim 50, wherein the rights allocation component facilitates an initial allocation of rights via at least one of a random allocation, open auction, and blind auction.

60. The system of claim 50, wherein rights allocation component facilitates initial allocations of rights to players via an interactive process that allows players to submit bids for rights and allows for automated processing of bids and allocation of the rights.

61. The system of claim 50, wherein the rights allocation component makes available to players in the game bids submitted by one or more other players in the game.

62. The system of claim 50, wherein the rights allocation component does not make available to players in the game bids submitted by one or more other players in the game.

63. The system of claim 50, wherein the rights allocation component allows for proxy-style bidding.

64. The system of claim 50, wherein the rights allocation component allows for Dutch-auction style bidding.

65. The system of claim 50, wherein the rights allocation component allows for the player to set an amount of points in a corresponding game balance that the player desires to reserve in the balance and is not included in the processing of any bids.

66. The system of claim 50, wherein the rights allocation component facilitates exchanges in rights between players via exchanges of at least one of rights and points.

67. The system of claim 50, wherein the rights allocation component facilitates exchanges of rights between players via an interactive process that allows the players to make available or otherwise offer terms upon which the players are willing to exchange rights with other players, and allows the other players to accept or reject such offers.

68. The system of claim 67, wherein the interactive process made available through the rights allocation component facilitates exchanges of rights between players by allowing a mechanism for the players to submit counteroffers.

69. The system of claim 50, wherein during, upon completion of, and after the RLE, the event component provides game statistical information to players in the game.
